(19) United States
(12) Patent Application Publication
(10) Pub. No.: US 2024/0157568 A1
(43) Pub. Date: May 16, 2024

(54) SYSTEM FOR WELDING AT LEAST A PORTION OF A PIECE AND RELATED METHODS

(71) Applicant: POLY-ROBOTICS INC., Québec (CA)

(72) Inventors: Louis BERARD, Québec (CA); Mats DALLAIRE, Québec (CA); Jolain DALLAIRE, Québec (CA)

(21) Appl. No.: 18/552,507

(22) PCT Filed: Mar. 29, 2022
(86) PCT No.: PCT/CA2022/050465

§ 371 Date: Sep. 26, 2023

Related U.S. Application Data
(60) Provisional application No. 63/200,778, filed on Mar. 29, 2021.

(51) Int. Cl. B25J 9/16; B23K 31/02; B23K 31/12; B25J 11/00

(52) U.S. Cl. CPC B25J 9/1697; B23K 31/02; B23K 31/12; B25J 11/005

(57) ABSTRACT

The present disclosure concerns a system and associated method for welding a piece. The system includes a 6-axis welding robot including a robotized arm, a vision module and a computing device. The vision module is mounted to a fourth axis of the robotized arm and includes optical sources and a camera. The optical sources are operable to irradiate the piece along irradiation paths. The camera is configured to receive irradiated light from the piece and to generate image data. The computing device is operatively connected to the camera and includes non-transitory computer readable storage medium having stored instructions that, when executed by a processor causes the processor to receive the image data; obtain a reference welding path to be followed by the welding robot for welding the piece; send instructions to the welding robot to weld the piece according to the reference welding path.

### PRIOR APPLICATION

The present application claims priority from U.S. provisional patent application No. 63/200,778, filed on Mar. 29, 2021, and entitled “SYSTEM FOR WELDING A PIECE AND RELATED METHODS”, the disclosure of which being hereby incorporated by reference in its entirety.

### TECHNICAL FIELD

The technical field generally relates to industrial robotics, and more particularly relates to systems for welding a piece, and related methods.

### BACKGROUND

Techniques for automating welding processes are known in the art. Robot-based systems and methods for welding pieces are one example of such techniques. However, existing solutions suffer from numerous drawbacks such as, for example, relatively limited precision and reproducibility, relatively long periods of downtime and/or suboptimal cycle times. In addition, some of the existing solutions are not suited for pieces having a relatively complex profile or topology, which may affect the overall quality of the welding process.

There remains a need for a method or system that can provide improvements in methods and systems for welding pieces.

### SUMMARY

In accordance with one aspect, there is provided a method for welding at least a portion of a piece with a welding robot. The method includes providing a virtual representation of the least portion of the piece to be welded in a virtual environment; determining a layout of a welding joint on the virtual representation; obtaining a reference welding path of the welding robot based on the layout of the welding joint on the virtual representation; operating the welding robot to weld the least portion of the piece according to the determined reference welding path.

In some embodiments, said providing the virtual representation includes obtaining, generating, calculating or processing virtual models or virtual images.

In some embodiments, said providing the virtual representation is based on a virtual reference image.

In some embodiments, the method further includes calculating the virtual reference image.

In some embodiments, said calculating the virtual reference image includes determining a tangential direction (Ts) at a surface of the at least portion of the piece, the tangential direction being expressed as a cross product of a vector normal to the surface at a given point (Ns) and a vector tangential to the surface at the given point (Tp) of the laser profile, according to the following equation:

Ts=Tp×Ns

In accordance with another aspect, there is provided a system for welding at least a portion of a piece. The system includes a 6-axis welding robot including a robotized arm, the robotized arm having first to sixth axes, a vision module and a computing device. The vision module is mounted to a fourth axis of the robotized arm and includes at least one optical source and a camera. The at least one optical source is operable to irradiate the at least portion of the piece along at least two different irradiation paths. The camera is configured to receive light emanating from the at least portion of the piece upon irradiation by the at least one optical source and to generate therefrom image data representative of the at least portion of the piece to be welded. The computing device is operatively connected to the camera, and includes non-transitory computer readable storage medium having stored thereon computer executable instructions that, when executed by a processor causes the processor to receive the image data generated by the camera; obtain, based on the image data, a reference welding path to be followed by the 6-axis welding robot for welding the at least portion of the piece; send instructions to the 6-axis welding robot to weld the at least portion of the piece according to the reference welding path.

In some embodiments, the vision module includes at least one profilometer.

In some embodiments, the at least one optical source includes a first optical source and a second optical source, wherein the first optical source is configured to irradiate a first irradiation path of the at least two irradiation paths and the second optical source is configured to irradiate a second irradiation path of the at least two irradiation paths.

In some embodiments, the first optical source is a first laser source.

In some embodiments, the second optical source is a second laser source.

In some embodiments, the first optical source is configured to emit a first light beam and the second optical source is configured to emit a second light beam, the first light beam having a first spatial profile and the second light beam having a second spatial profile, the first spatial profile and the second spatial profile being line shaped.

In some embodiments, the first light beam is associated with a first illumination plane and the second light beam is associated with a second illumination plane, the camera being configured to receive a projection of an intersection of the first illumination plane, the second illumination plane, and the at least portion of the piece.

In some embodiments, the image data representative of the at least portion of the piece conveys information about a location of at least one welding joint.

In some embodiments, the instructions cause a relative movement between the robotized arm and the at least portion of the piece.

In some embodiments, receiving the image data includes acquiring the image data.

In some embodiments, the camera has a substantially square field of view, the field of view having a side length ranging from about 30 mm to about 120 mm.

In some embodiments, the system further includes mechanical fasteners configured to mount the vision module on the fourth axis of the robotized arm.

In some embodiments, the mechanical fasteners include:
a first support, the first support being provided on a middle portion of an upper arm of the robotized arm associated with the fourth axis, the first support being configured to hold the camera and one of the first optical source and the second optical source; and
a second support provided on a bottom portion of the upper arm of the robotized arm associated with the fourth axis, the second support being configured to hold a remaining one of the first optical source and the second optical source.

In some embodiments, the camera has a working distance ranging between 300 mm and 1000 mm.

In some embodiments, the working distance is adjustable.

In some embodiments, the computing device is operatively connected to a database adapted to store at least one of reference images, reference data and reference points.

In accordance with another aspect, there is provided a method for adjusting a vision module of a system for welding at least a portion of a piece, the system includes a 6-axis welding robot. The method includes providing a virtual representation of the at least portion of the piece to be welded; obtaining an image representation of the at least portion of the piece with a vision module, the vision module is mounted on a fourth axis of the 6-axis welding robot; and determining at least one discrepancy between the virtual representation and the obtained image representation of the at least portion of the piece, and upon determination of a discrepancy between the virtual representation and the image representation, adjusting an operation of the vision module with respect to the at least portion of the piece.

In some embodiments, said obtaining the image representation includes acquiring the visual representation of the at least portion of the piece.

In some embodiments, the method further includes:
irradiating the at least portion of the piece with a first light beam produced with a first optical source, the first light beam being associated with a first illumination plane;
irradiating the at least portion of the piece with a second light beam produced with a second optical source, the second light beam being associated with a second illumination plane.

In some embodiments, the method further includes imaging an intersection of the first illumination plane, the second illumination plane, and the at least portion of the piece.

In some embodiments, the method further includes adjusting a working distance of the camera.

In some embodiments, determining at least one discrepancy between the virtual representation and the obtained image representation of the at least portion of the piece includes calculating a mismatch between a virtual position of a welding joint in a virtual environment and a real position of the welding joint in a physical environment.

In some embodiments, the method further includes adjusting at least one of a position and an orientation of the at least one optical source with respect to the at least portion of the piece.

In some embodiments, said providing the virtual representation of the at least a portion of the piece to be welded includes determining a virtual image representation of a laser profile across a welding joint of the at least portion of the piece.

In some embodiments, the method further includes readjusting an image acquisition position to maintain a reference point in a laser plane, said readjusting the image acquisition position including aligning a vertical axis of the laser plane with a bisector of an angle formed by at least two sides of the welding joint of the at least portion of the piece, such that the vertical axis is substantially parallel to the bisector of the angle.

In accordance with another aspect, there is provided a system for welding at least a portion of a piece. The system includes a 6-axis welding robot including a robotized arm, the robotized arm having first to sixth axes, a vision module and a computing device. The vision module is mounted to a fourth axis of the robotized arm and includes at least one optical source and a camera. The at least one optical source is operable to irradiate the at least portion of the piece along at least two different irradiation paths. The camera is configured to receive light emanating from the at least portion of the piece upon irradiation by the at least one optical source and to generate therefrom image data representative of the at least portion of the piece to be welded. The computing device is operatively connected to the camera, and includes a reception module adapted to receive the image data generated by the camera; a pathing module adapted to obtain, based on the image data, a reference welding path to be followed by the 6-axis welding robot for welding the at least portion of the piece; and an output module adapted to send instructions to the 6-axis welding robot to weld the at least portion of the piece according to the reference welding path.

In some embodiments, the vision module includes at least one profilometer.

In some embodiments, the at least one optical source includes a first optical source and a second optical source, wherein the first optical source is configured to irradiate a first irradiation path of the at least two irradiation paths and the second optical source is configured to irradiate a second irradiation path of the at least two irradiation paths.

In some embodiments, the first optical source is a first laser source.

In some embodiments, the second optical source is a second laser source.

In some embodiments, the first optical source is configured to emit a first light beam and the second optical source is configured to emit a second light beam, the first light beam having a first spatial profile and the second light beam having a second spatial profile, the first spatial profile and the second spatial profile being line shaped.

In some embodiments, the first light beam is associated with a first illumination plane and the second light beam is associated with a corresponding second illumination plane, the camera being configured to receive a projection of an intersection of the first illumination plane, the second illumination plane, and the at least portion of the piece.

In some embodiments, the image data representative of the at least portion of the piece conveys information about a location of at least one welding joint.

In some embodiments, the instructions cause a relative movement between the robotized arm and the at least portion of the piece.

In some embodiments, receiving the image data includes acquiring the image data.

In some embodiments, the camera has a substantially square field of view, the field of view having a side length ranging from about 30 mm to about 120 mm.

In some embodiments, the system further includes mechanical fasteners configured to mount the vision module on the fourth axis of the robotized arm.

In some embodiments, the mechanical fasteners include:
a first support, the first support being provided on a middle portion of an upper arm of the robotized arm associated with the fourth axis, the first support being configured to hold the camera and one of the first optical source and the second optical source; and
a second support provided on a bottom portion of the upper arm of the robotized arm associated with the fourth axis, the second support being configured to hold a remaining one of the first optical source and the second optical source.

In some embodiments, the camera has a working distance ranging between 300 mm and 1000 mm.

In some embodiments, the working distance is adjustable.

In some embodiments, the computing device is operatively connected to a database adapted to store at least one of reference images, reference data and reference points.

In accordance with another aspect of the present description, there is provided a non-transitory computer readable storage medium having stored thereon computer executable instructions that, when executed by a processor, cause the processor to perform the methods being herein disclosed, or at least one step thereof.

In accordance with another aspect, there is provided a method for welding a piece with a welding robot. The method includes providing a virtual model representative of the piece in a virtual environment; determining a layout of a welding joint on the virtual model; determining a welding trajectory of the welding robot based on the layout of the welding joint determined on the virtual model; and operating the welding robot to weld the piece according to the welding trajectory determined in the virtual environment. In some embodiments, determining the layout of the welding joint may include obtaining a welding trajectory and adjusting the welding trajectory to compensate for imperfections that may be present on the piece. In some embodiments, the welding trajectory may be provided by an external computer program or may be created by a user.

In accordance with another aspect, there is provided a system for welding a piece. The system includes a 6-axis welding robot having first to sixth axes, a vision module and a processor. The vision module is mounted to the fourth axis of the 6-axis welding robot and includes two optical sources and a camera. The two optical sources are operable to irradiate the piece along two different irradiation paths. The camera is configured to collect light emanating from the piece upon irradiation by the two lasers and to generate therefrom image data conveying information about the piece to be welded. The processor is configured to receive the image data generated by the camera; determine, from the image data, a welding trajectory to be followed by the 6-axis welding robot for welding the piece; and control the 6-axis welding robot to weld the piece according to the welding trajectory.

In accordance with another aspect, there is provided a method for calibrating a vision module of a system for welding a piece. The method includes providing a virtual model of the piece; acquiring an image of the piece with the vision module; and comparing the acquired image with the virtual model. Upon determination of a mismatch between the virtual model and the image, the method includes adjusting an operation of the vision module in the system based on the mismatch.

In accordance with another aspect, there is provided A method for assisting a welding process of at least a portion of a piece with a welding robot, the method including: pre-filtering a real image of the at least portion of the piece; adjusting a luminosity level in the real image to remove expected artefacts from at least one optical source; matching a shape of a real laser profile to a shape of a virtual reference profile, and obtaining a distance between the real laser profile and the reference laser profile; processing a luminance signal to identify a center of the real laser profile; and recalculating the distance between the center of the real laser profile and the virtual reference laser profile.

In accordance with another aspect, there is provided a non-transitory computer readable-storage medium having stored thereon computer readable instructions for adjusting a vision module of a system for welding at least a portion of a piece, the system including a 6-axis welding robot, the instructions causing one or more processors to perform a method, the method including: providing a virtual representation of the at least a portion of the piece to be welded; obtaining an image representation of the at least portion of the piece with a vision module, the vision module being mounted on a fourth axis of the 6-axis welding robot; and determining at least one discrepancy between the virtual representation and the obtained image representation of the at least portion of the piece, and upon determination of a discrepancy between the virtual representation and the image representation, adjusting an operation of the vision module with respect to the at least portion of the piece.

In some embodiments, said obtaining the image representation includes acquiring the visual representation of the at least portion of the piece.

In some embodiments, the method further includes irradiating the at least portion of the piece with a first light beam produced with a first optical source, the first light beam being associated with a first illumination plane; and irradiating the at least portion of the piece with a second light beam produced with a second optical source, the second light beam being associated with a second illumination plane.

In some embodiments, the method further includes imaging an intersection of the first illumination plane, the second illumination plane, and the at least portion of the piece.

In some embodiments, the method further includes adjusting a working distance of the camera.

In some embodiments, determining at least one discrepancy between the virtual representation and the obtained image representation of the at least portion of the piece includes calculating a mismatch between a virtual position of a welding joint in a virtual environment and a real position of the welding joint in a physical environment.

In some embodiments, the method further includes adjusting at least one of a position and an orientation of the at least one optical source with respect to the at least portion of the piece.

In some embodiments, said providing the virtual representation of the at least a portion of the piece to be welded includes determining a virtual image representation of a laser profile across a welding joint of the at least portion of the piece.

In some embodiments, the method further includes readjusting an image acquisition position to maintain a reference point in a laser plane, said readjusting the image acquisition position including aligning a vertical axis of the laser plane with a bisector of an angle formed by at least two sides of the welding joint of the at least portion of the piece, such that the vertical axis is substantially parallel to the bisector of the angle.

In accordance with another aspect, there is provided a non-transitory computer readable-storage medium having stored thereon computer readable instructions for welding at least a portion of a piece with a welding robot, the instructions causing one or more processors to perform a method, the method including: providing a virtual model of the least portion of the piece to be welded in a virtual environment; determining a layout of a welding joint on the virtual model; obtaining a reference welding path of the welding robot based on the layout of the welding joint on the virtual model; and operating the welding robot to wield the least portion of the piece according to the determined reference welding path.

In some embodiments, providing the virtual representation includes obtaining, generating, calculating or processing virtual models or virtual images.

In some embodiments, said providing the virtual representation is based on a virtual reference image.

In some embodiments, the method further includes calculating the virtual reference image.

In some embodiments, said calculating the virtual reference image includes determining a tangential direction (Ts) at a surface of the at least portion of the piece, the tangential direction being expressed as a cross product of a vector normal to the surface at a given point (Ns) and a vector tangential to the surface at the given point (Tp) of the laser profile, according to the following equation:

Ts=Tp×Ns

Other features and advantages of the method and system described herein will be better understood upon a reading of preferred embodiments thereof with reference to the appended drawings. Although specific features described in the above summary and in the detailed description below may be described with respect to specific embodiments or aspects, it should be noted that these specific features can be combined with one another unless stated otherwise.

### BRIEF DESCRIPTION OF THE DRAWINGS

FIGS. 1 is a front perspective view of a 6-axis welding robot having a robotized arm, the robotized arm having first to sixth axes and a welder on the sixth axis.

FIG. 2 is a close-up perspective view of the 6-axis welding robot, in which the welder is positioned to weld a piece, according to an embodiment.

FIG. 3 is a front perspective view of the system for welding at least a portion of a piece, with a vision module having a camera and two optical sources, the vision module being mounted on the fourth axis of the 6-axis welding robot of FIG. 1 and a computing device in communication with the vision module and the 6-axis welding robot, according to an embodiment.

FIG. 4 is a close-up front perspective view of the fourth axis of the 6-axis welding robot, illustrating irradiation paths of the optical sources and a reference frame of the fourth axis with respect to the vision module.

FIG. 5 is a front perspective view of the representation of the 6-axis welding robot of FIGS. 1 to 4 in a virtual environment, according to an embodiment.

FIGS. 6a and 6b are close-up views of the vision module, illustrating one of the optical sources irradiating a piece with a light source plane and the camera capturing the light source plane. FIG. 6a illustrates the camera and the optical source, according to an embodiment. FIG. 6b illustrates the upper arm of the 6-axis welding robot, according to an embodiment.

FIG. 7 (PRIOR ART) is a front perspective view illustrating a vision system mounted on the welding robot, according to prior art.

FIG. 8 (PRIOR ART) is a close-up perspective view the welding robot of FIG. 7, positioned to weld a piece (PRIOR ART).

FIG. 9 is a close-up perspective view of the 6-axis welding robot of FIG. 3, illustrating the vision module mounted on the fourth axis, wherein the welder is positioned to weld a piece, according to an embodiment.

FIG. 10 is an exploded front perspective view of the vision module, illustrating mechanical fasteners having a first and second support adapted to hold the optical sources and the camera, according to an embodiment.

FIG. 11 is a flowchart illustrating the different steps of a method for welding at least a portion of a piece with a welding robot, according to an embodiment.

FIG. 12 is a schematic view illustrating an offset between a virtual laser profile and a real laser profile, according to an embodiment.

FIG. 13 is a schematic view illustrating a real laser profile, according to an embodiment.

FIG. 14 is a flowchart illustrating a teaching phase and a running phase of the method of FIG. 11.

FIG. 15 is a flowchart illustrating the steps of the method illustrated in FIG. 11, according to an embodiment.

FIG. 16 is a flowchart illustrating some steps of the method illustrated in FIG. 11, wherein the steps are conducted to locate a welding joint, according to an embodiment.

FIG. 17 is a flowchart illustrating some steps of the method illustrated in FIG. 11, wherein the steps are conducted to create a reference database, according to an embodiment.

FIG. 18 is a flowchart illustrating some steps of the method illustrated in FIG. 17, wherein the sub step is conducted to create a database item, according to an embodiment.

FIG. 19 is a flowchart illustrating some steps of the method illustrated in FIG. 11, wherein the steps are conducted to generate an image, according to an embodiment.

FIG. 20 is a flowchart illustrating some steps of the method illustrated in FIG. 11, wherein the steps are conducted to generate laser profile, according to an embodiment.

FIG. 21 is a flowchart illustrating some steps of the method illustrated in FIG. 11, wherein the steps are conducted to create a calibration file, according to an embodiment.

FIGS. 22a and 22b present a flowchart illustrating steps of a universal method for welding at least a portion of a piece with a welding robot, according to an embodiment.

FIG. 23 is a flowchart illustrating some steps of the method illustrated in FIG. 11, where the steps are conducted to convert a position of a pixel into a 3D position, according to an embodiment.

FIG. 24 is a flowchart illustrating a sub step of the method illustrated in FIG. 17, wherein the sub step is conducted to update the database, according to an embodiment.

FIG. 25 is a flowchart illustrating steps of a method for adjusting a vision module of a system for welding at least a portion of a piece, wherein the system includes a 6-axis welding robot, according to an embodiment.

### DETAILED DESCRIPTION

In the present description, similar features in the drawings have been given similar reference numerals. To avoid cluttering certain figures, some elements may not have been indicated if they were already identified in a preceding figure. It should also be understood that the elements of the drawings are not necessarily depicted to scale, since emphasis is placed on clearly illustrating the elements and structures of the present embodiments. Furthermore, positional descriptors indicating the location and/or orientation of one element with respect to another element are used herein for ease and clarity of description. Unless otherwise indicated, these positional descriptors should be taken in the context of the figures and should not be considered limiting. More particularly, it will be understood that such spatially relative terms are intended to encompass different orientations in the use or operation of the present embodiments, in addition to the orientations exemplified in the figures.

The terms “a”, “an” and “one” are defined herein to mean “at least one”, that is, these terms do not exclude a plural number of items, unless stated otherwise.

Terms such as “substantially”, “generally” and “about”, that modify a value, condition or characteristic of a feature of an exemplary embodiment, should be understood to mean that the value, condition or characteristic is defined within tolerances that are acceptable for the proper operation of this exemplary embodiment for its intended application.

Unless stated otherwise, the terms “connected” and “coupled”, and derivatives and variants thereof, refer herein to any structural or functional connection or coupling, either direct or indirect, between two or more elements. For example, the connection or coupling between the elements may be acoustical, mechanical, optical, electrical, thermal, logical, or any combinations thereof.

Expressions such as “match”, “matching” and “matched”, including variants and derivatives thereof, are intended to refer herein to a condition in which two or more elements are either the same or within some predetermined tolerance of each other. That is, these terms are meant to encompass not only “exactly” or “identically” matching the two elements but also “substantially”, “approximately” or “subjectively” matching the two or more elements, as well as providing a higher or best match among a plurality of matching possibilities.

In the present description, the expression “based on” is intended to mean “based at least partly on”, that is, this expression can mean “based solely on” or “based partially on”, and so should not be interpreted in a limited manner. More particularly, the expression “based on” could also be understood as meaning “depending on”, “representative of”, “indicative of”, “associated with” or similar expressions.

In the present description, the terms “light” and “optical”, and variants and derivatives thereof, are used to refer to radiation in any appropriate region of the electromagnetic spectrum. The terms “light” and “optical” are therefore not limited to visible light, but can also include, without being limited to, the infrared and ultraviolet regions. For example, in some implementations, the present techniques can be used with electromagnetic signals having wavelengths ranging from about 400 nm to about 700 nm. However, this range is provided for illustrative purposes only and some implementations of the present techniques may operate outside this range. Also, the skilled person will appreciate that the definition of the ultraviolet, visible and infrared ranges in terms of spectral ranges, as well as the dividing lines between them, can vary depending on the technical field or the definitions under consideration, and are not meant to limit the scope of applications of the present techniques.

The term “computer” (or “computing device”) is used to encompass computers, servers and/or specialized electronic devices which receive, process and/or transmit data. Computers are generally part of “systems” and include processing means, such as microcontrollers and/or microprocessors, CPUs or are implemented on FPGAs, as examples only. The processing means are used in combination with storage medium, also referred to as “memory” or “storage means”. Storage medium can store instructions, algorithms, rules and/or data to be processed. Storage medium encompasses volatile or non-volatile/persistent memory, such as registers, cache, RAM, flash memory, ROM, as examples only. The type of memory is, of course, chosen according to the desired use, whether it should retain instructions, or temporarily store, retain or update data. One skilled in the art will therefore understand that each such computer typically includes a processor (or multiple processors) that executes program instructions stored in the memory or other non-transitory computer-readable storage medium or device (e.g., solid state storage devices and/or disk drives. The various functions, modules, services, units or the like disclosed hereinbelow can be embodied in such program instructions, and/or can be implemented in application-specific circuitry (e.g., ASICs or FPGAs) of the computers. Where a computer system includes multiple computers, these devices can, but need not, be co-located. In some embodiments, a computer system can be a cloud-based and/or virtualized (i.e., virtual machine or container) computing system whose processing resources are shared by multiple distinct business entities or other users.

The present description generally relates to systems for welding at least a portion of a piece and related methods. It should be noted that the expression “at least a portion of a piece”, derivatives and synonyms thereof, refers to the welding of a piece (i.e., a “whole piece”, a “complete piece” or a piece in its entirety), as much as a segment of a piece (one or more portions of a piece). In some embodiments, only a portion of the piece can be welded whereas, in other embodiments, a plurality of portions of the piece can be welded. For alignment or maintainability purposes, the welding techniques can be referred in the art as stapling a piece (e.g., welding small dot-shape regions or zones along a piece). As such, the expression “welding a piece” is not limited to the whole piece and can in some instances be interchanged with the expression “welding at least a portion of a piece” as measure of simplicity and readability.

In some embodiments, the systems herein disclosed include a 6-axis welding robot and a vision module mounted on a fourth axis of the 6-axis welding robot, as it will be presented in greater detail below. In some embodiments, the methods herein disclosed include determining a welding path, which may be referred to as a “welding trajectory”, of a welding robot based on a layout of the welding joint, the layout of the welding joint being determined based on a virtual model representative of a piece in a virtual environment.

It should be noted that, in the context of the current disclosure, the expression “layout”, synonyms and derivatives thereof, refer to the shape, geometry and/or dimensions of the welding joint, and may also be used to refer to an outline, a contour or an external surface of the welding joint. The welding robot can be operated to weld the piece according to the welding path.

Now turning to the Figures, embodiments of a system for welding at least a portion of a piece will be described. The system includes a 6-axis welding robot, a vision module, and a computing device.

6-axis welding robots, such as the one illustrated by reference number 50 in the Figures, are a subclass of articulated robots that allow for relatively complex, precise, and repetitive movements for a broad variety of applications. Such robots can generally move in three planes (e.g., x, y, and z planes), and can also roll, pitch and yaw. The 6-axis welding robot 50 according to the described embodiments feature six axes, that may be labelled as “first to sixth axes” 51a-51f. The 6-axis welding robot 50 also includes arms, such as a lower arm and an upper arm. The lower arm may be mechanically connected to a base of the 6-axis robot 50. A nonlimitative example of a mechanical connection between the lower arm 52 and the base 56 is what is known in the art as a “shoulder” 58. Of course, any types of mechanical connection or articulation could be used. The lower arm 52 may be rotatively mounted to the shoulder 58 and the shoulder 58 may be rotatively mounted to the base 56. The upper arm 54 may be mechanically connected to the lower arm 52 by what is known in the art as an “elbow” 57. Of course, any types of mechanical connection or articulation could be used. The upper arm 54 may be rotatively mounted to the elbow 57, and the elbow 57 may be rotatively mounted to the lower arm 52. The upper arm 54 is generally configured to hold a tool 60, which may be, for example and without being limitative, a welder 60 (sometimes referred to as a “welding gun”). The 6-axis welding robot 50 also includes a wrist 59, located between the tool 60 and the elbow 57, which allows the tool 60 to be coupled to the upper arm 54. Of note, the tool 60 and the upper arm 54 may be mechanically and/or electronically coupled. Each one of the six axes 51a-51f is associated with at least one corresponding “action” or “movement” (e.g., translation, extension, rotation, extension, and the like) of one the arms or a portion thereof. The first axis (or “axis 1”) 51a is generally associated with the rotation of the base 56 of the 6-axis welding robot 50. The second axis (or “axis 2”) 51b is generally associated with the forward and backward extension of the lower arm 52 of the 6-axis welding robot. The third axis (or “axis 3”) 51c is generally associated with raising and lowering the upper arm 54 of the 6-axis welding robot 50. The fourth axis (or “axis 4”) 51d is generally associated with the rotation of the upper arm 54 of the 6-axis welding robot 50 (also known as a “wrist roll”). The fifth axis (or “axis 5”) 51e is generally associated with raising and lowering the wrist 59 of the 6-axis welding robot 50. The sixth axis (or “axis 6”) 51f is generally associated with the rotation of the wrist 59 of the 6-axis welding robot 50.

In some embodiments, the 6-axis welding robot 50 may not be limited to 6 axes and may further comprise a seventh axis (not shown). The seventh axis may be associated with an extra rotation and/or translation of the 6-axis welding robot 50. For instance, the seventh axis may be associated with an extra rotation of the lower arm 52, i.e., at a rotation point between the second axis and the third axis (axis 2 and axis 3). In some embodiments, the seventh axis may be associated with a rotation plate operatively connected to the base 56 (e.g., mounted underneath the base 56 or the first axis 51a), allowing an extra rotation of the base 56 and/or the whole 6-axis welding robot 50. In another example, the seventh axis may instead be associated with a translation axis, for example a railing/sliding mechanism, in which the base of the 6-axis welding robot 50 can translate in a linear direction. In other words, the seventh axis can be positioned between two axes or at the end of one of the first or sixth axis 51a, 51f, in order to add an extra degree of freedom. It is understood that said position of the seventh axis is not limited to the above examples and may be positioned at another location on or in conjunction with the 6-axis welding robot 50.

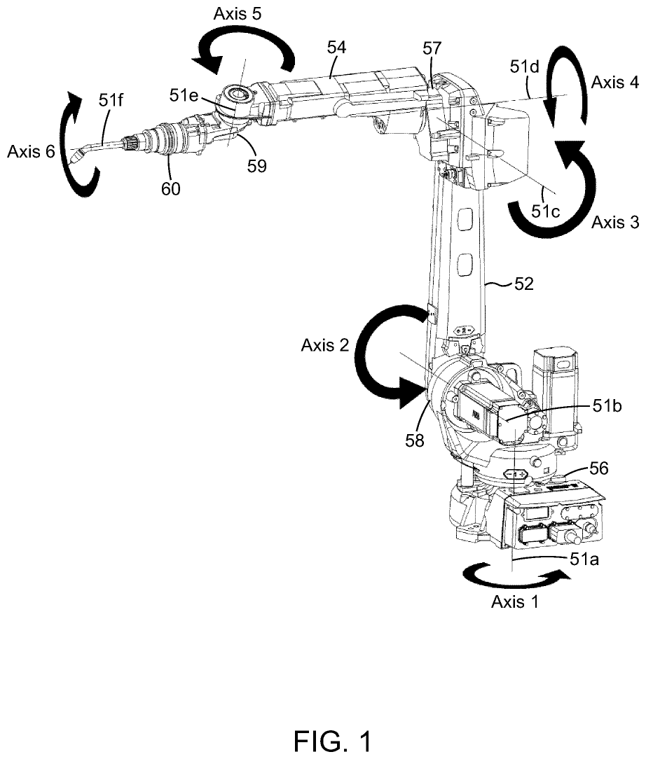

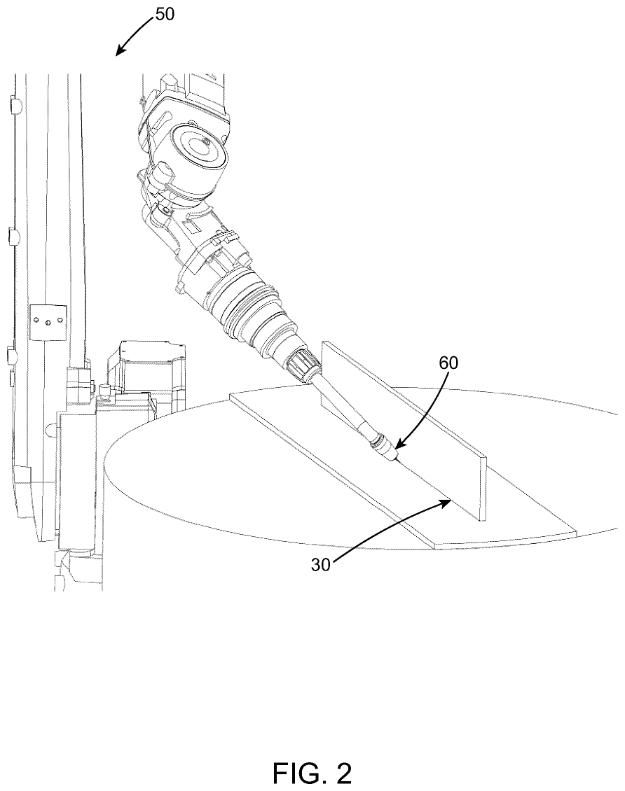

A nonlimitative embodiment of a 6-axis welding robot 50 is illustrated in FIG. 1. As illustrated, a relative movement about any of the first, second and third axes 51a,51b, 51c allows moving the welder 60, such that it can be positioned at an appropriate position (sometimes referred to as a “welding position”). It will have been readily understood that the appropriate position depends on the application but is generally defined in relation with the welding joint 30 or a portion thereof, and its corresponding layout. An example of a welder 60 being placed at the appropriate position is illustrated in FIG. 2, wherein the welder 60 is properly oriented with respect to the welding joint 30. Referring back to FIG. 1, the fourth, fifth and sixth axes 51d, 51e, 51f allow rotating the welder 60, so that the orientation relative of the welder 60 with respect to the welding joint 30 may remain substantially constant or may otherwise be controlled during the welding process.

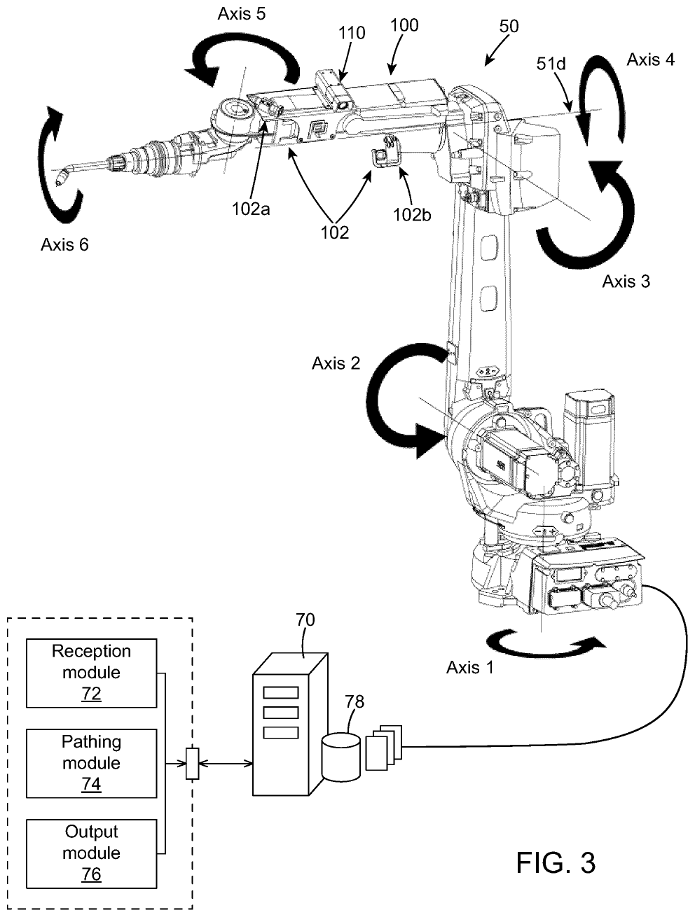

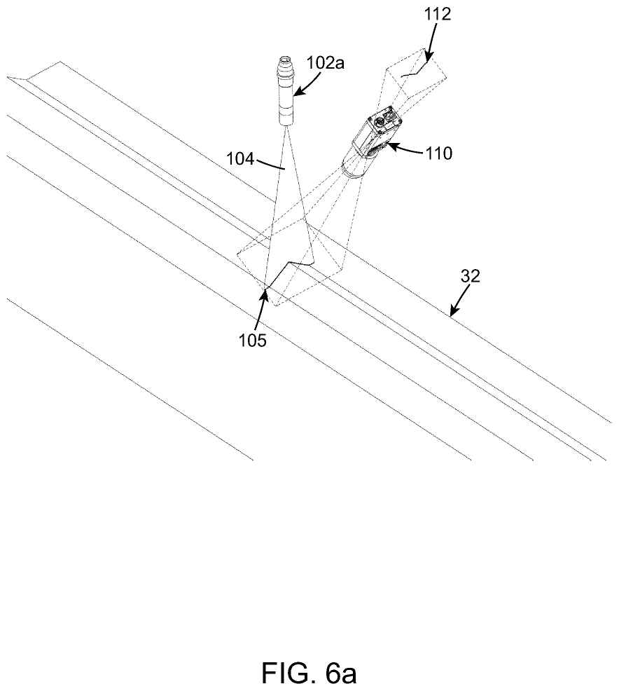

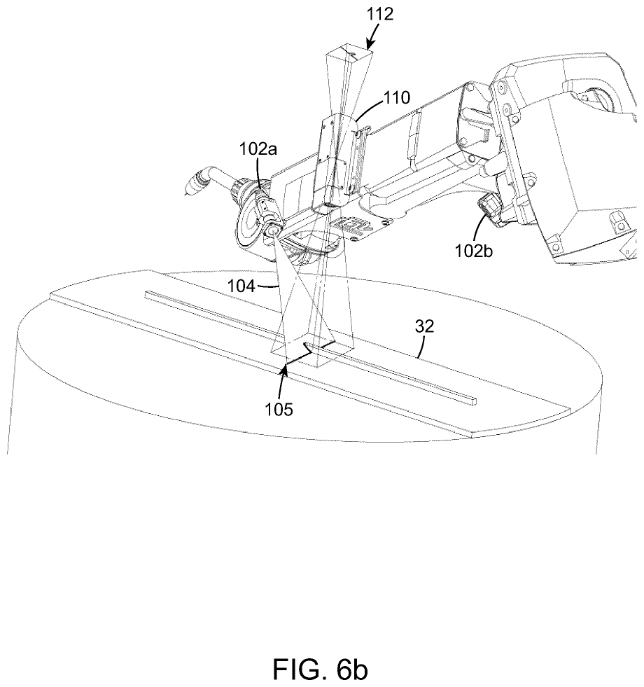

The vision module 100, illustrated throughout FIGS. 3 to 6, is configured to collect information representative of the location of welding joints 30 on pieces 32 (illustrated in FIGS. 6a and 6b, for example). The pieces 32 may be embodied by any types of industrial components, such as, to name a few, antenna towers (e.g., made from aluminum), water tanks, hot water tanks, oil tanks, tubes, pipeline tubes, saw bases (or portions thereof), columns (e.g., steel columns), containers, truck components, trucks boxes or beds, truck bodies, anode assemblies for aluminum smelters and many others. The collected information is then used by the computing device 70 (illustrated in FIG. 3) to control or operate the 6-axis welding robot 50, which may include, for example and without being limitative, placing the welder at the required position with respect to the welding joints 30, and thereafter enabling the welding process of the pieces.

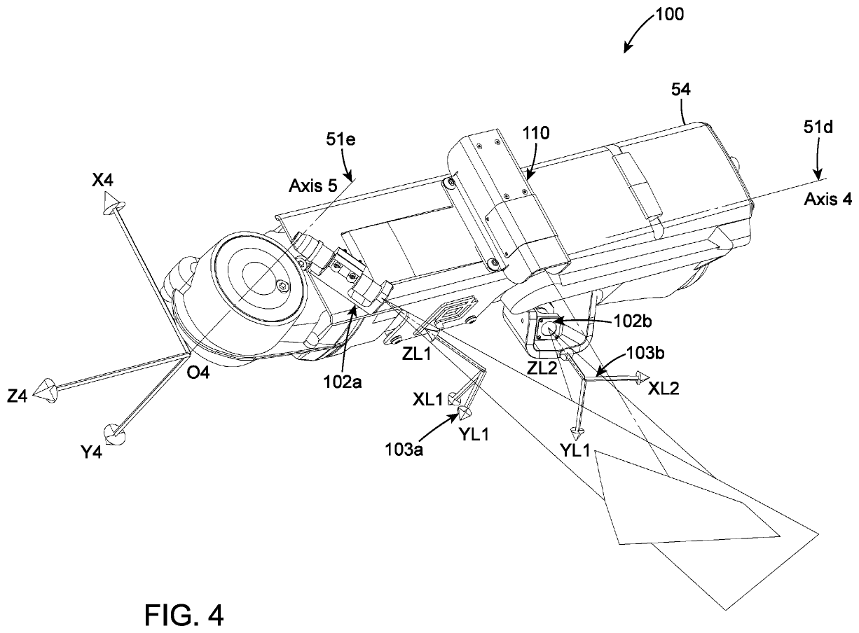

As illustrated in FIG. 3, the vision module 100 is mounted to the fourth axis 51d of the 6-axis welding robot 50. As better seen in FIG. 4, the vision module comprises at least one optical source 102 operable to irradiate the piece or portion of the piece (not illustrated in this Figure) along two different irradiation paths 103a, 103b and a camera 110 configured to receive (or in some embodiments collect or obtain) light emanating from the piece upon irradiation by the at least one optical source 102 and to generate therefrom image data information representative about the piece to be welded. More specifically, in the illustrated embodiment, the vision module includes two optical sources 102a, 102b represented as a first source 102a and a second optical source 102b. Each one of the two optical sources 102a, 102b may be operable to irradiate the piece along one of the two irradiation paths 103a, 103b. For instance, the first optical source 102a can irradiate along a first optical path 103a and the second optical source 102b can irradiate along a second optical path 103b. It should be understood, however, that the at least one optical source 102, may be provided as a single optical source configured to irradiate at two separate locations. In a similar manner, more than two optical sources may be provided to irradiate the piece along other different irradiation paths (e.g., third or fourth irradiation paths, for example).

In some embodiments, such as the one illustrated in FIGS. 6a and 6b, the vision module 100 relies on laser profilometry to perform the measurements. In these embodiments, two laser sources 102a, 102b may be used (i.e., corresponding to the optical sources 102), each being configured to emit a light beam having a spatial profile 105 resembling the shape of a line at an intersection between the light beams and the piece. Each one of the light beams may be associated with a corresponding laser plane 104 (or more broadly defined light source plane) and illuminate the piece from a different viewpoint. Of note, other types of optical sources (e.g., non-laser sources) could additionally or alternatively be used.

Light emanating from the illuminated piece may be detected by a sensor, such as a camera 110, to generate image data conveying information about the piece to be. The image data may be processed or analyzed, for example by extracting and reviewing some of the image points corresponding to a laser profile 112, i.e., the projection in the camera 110 of the intersection between the laser planes 104 and the piece or portion of piece 32. The purpose of the analysis is globally to determine whether a pixel of the image is part of the laser profile 112 or not. Such a determination may be made by determining the luminance of each pixel, and assuming that the brightest pixels form the laser profile 112. If the vision module 100, and more particularly the two optical sources 102a, 102b have been adequately calibrated, each bright pixel should correspond to a point on the real laser profile. Thresholding methods may be used to identify the brightest pixels corresponding to the laser profile 112. Assuming that the positions of the two optical sources 102a, 102b and the camera 110 are known, then it is possible to calculate the exact position of the laser profile in 3D space.

FIG. 4 shows a nonlimitative example of a possible orientation of a reference frame associated with the fourth axis 51d. The reference frame associated with the fourth axis 51d may be represented by the vectors X4, Y4 and Z4. As illustrated, the vector Z4 is parallel to the length of the upper arm 54 of the 6-axis welding robot 50, and coincident with the fourth axis 51d. The vector Y4 is parallel to the fifth axis 51e and allows the wrist (not illustrated in this Figure) of the 6-axis welding robot 50 to tilt up and down. The vector X4 is orthogonal to the plane formed by the vectors Y4 and Z4. Still referring to FIG. 4, the plane produced by the first optical source 102a is illustrated as being parallel to the vector Y4, and the plane produced by the second optical source 102b is illustrated as being parallel to the vector Z4. One of the two laser planes 103a, 103b produced by the two optical sources 102a,102b is substantially perpendicular to the welding joint. Accordingly, it should be noted that only one of the two planes 103a, 103b can generally be used at any given position, as the vision module 100 is mounted to the fourth axis 51d of the 6-axis welding robot 50. Consequently, it can be appreciated that in order to maximize the efficiency of the vision module 100, the two optical sources 102a, 102b can be configured so that only the one facing in direction of the piece 32 can irradiate the piece 32 or emit a light beam. For instance, depending on the positioning of the upper arm 54 with respect to the piece 32, either one of the two optical sources 102a, 102b can be turned on or produce illumination on the piece 32. For example, in a scenario where the first optical source 102a is facing the piece 32 (such as the one illustrated in FIG. 6b), the second optical source 102b can be refrained from irradiating or generating a light beam.

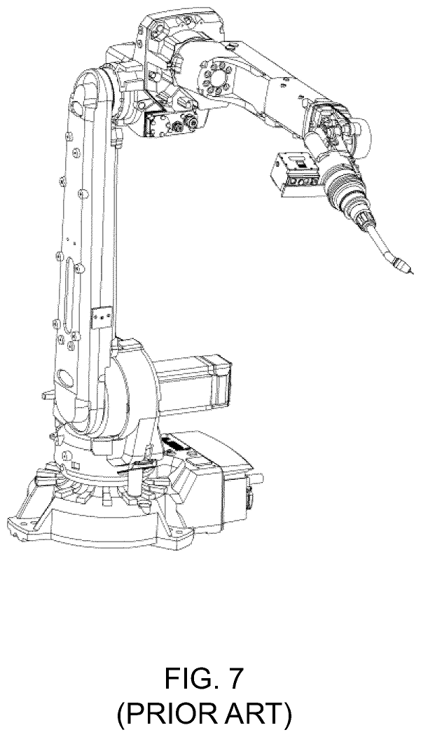

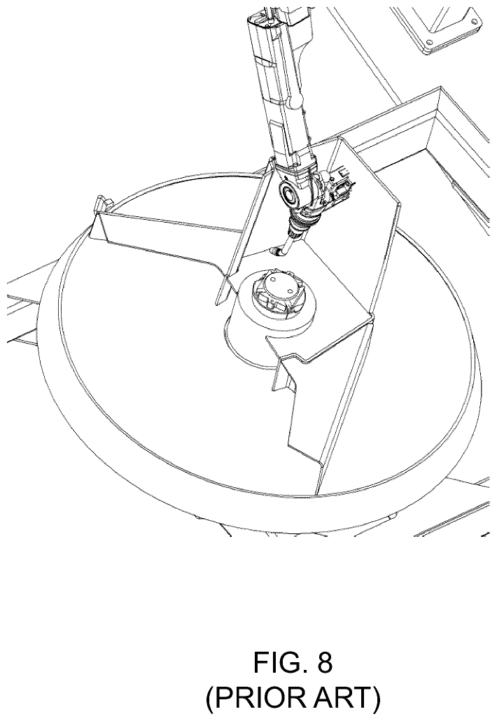

FIG. 7 (PRIOR ART) illustrates a conventional 6-axis robot, including a vision system installed close to the welder. FIG. 8 (PRIOR ART) shows why such a configuration might be problematic, as it may sometimes be impossible to access tight spaces, which is quite frequent with pieces having a layout including sharp edges, corners or angles. This is due to the presence of the relatively bulky vision system close to the welder.

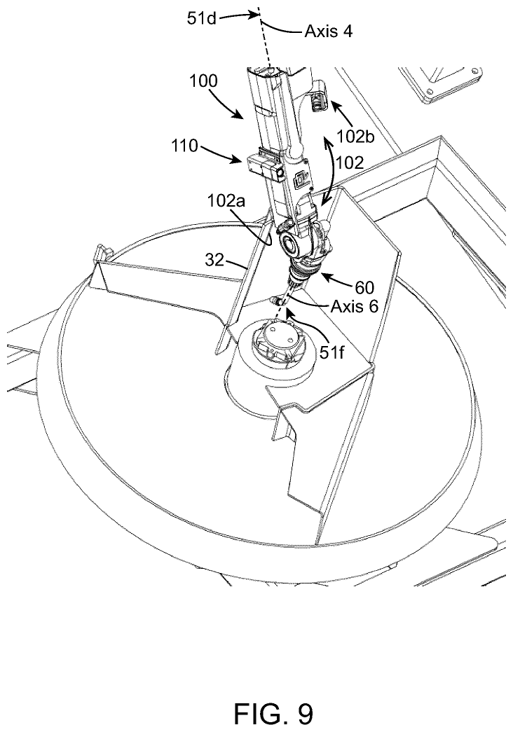

As illustrated in FIG. 9, positioning the vision module 100 on the fourth axis 51d eliminates or at least reduces the likelihood of any possible interferences between the piece 32 being weld or its surroundings and the vision module 100, or other cluttering issues, because the vision module 100 is relatively far from the welder 60 mounted on the sixth axis 51f. Of note, existing 6-axis welding robot 50 could be retrofitted, i.e., the vision module 100 of existing welding robots may be displaced, i.e., unmounted from its original position at the sixth axis 51f, and remounted at a new position at the fourth axis 51d. However, such a change in existing configurations is associated with numerous challenges. For example, and without being limitative, controllers usually provided with 6-axis welding robots are generally not configured to determine or calculate the position of the fourth axis 51d in a three-dimensional environment. Indeed, robot controllers of existing systems are generally built to determine or calculate the position of the sixth axis 51f, and then to adjust a relative movement of the welder 60 with respect to the sixth axis 51f.

Because the vision module 100 is mounted to the fourth axis 51f of the 6-axis welding robot 50, the camera 110 can only be displaced by adjusting the position of the 6-axis welding robot 50 along the first, second, third and fourth axis. The six axes of existing welding robots are generally required, because six degrees of freedom are typically needed to reach any positions in a 3D space. Limiting the movement of the 6-axis welding robot to four axes (i.e. , four degrees of freedom instead of six) can significantly reduce the number of positions and orientations that the vision module 100 could image.

Determining an appropriate position for the 6-axis welding robot to obtain an image of the piece is generally a compromise between a plurality of factors. One factor to consider is the distance between the camera and the focus plane, i.e., the distance at which the image is in focus for the camera. Of note, the vision module according to the present technology is further from the piece in comparison with existing systems, because the vision module is mounted on the fourth axis rather than on the sixth axis.

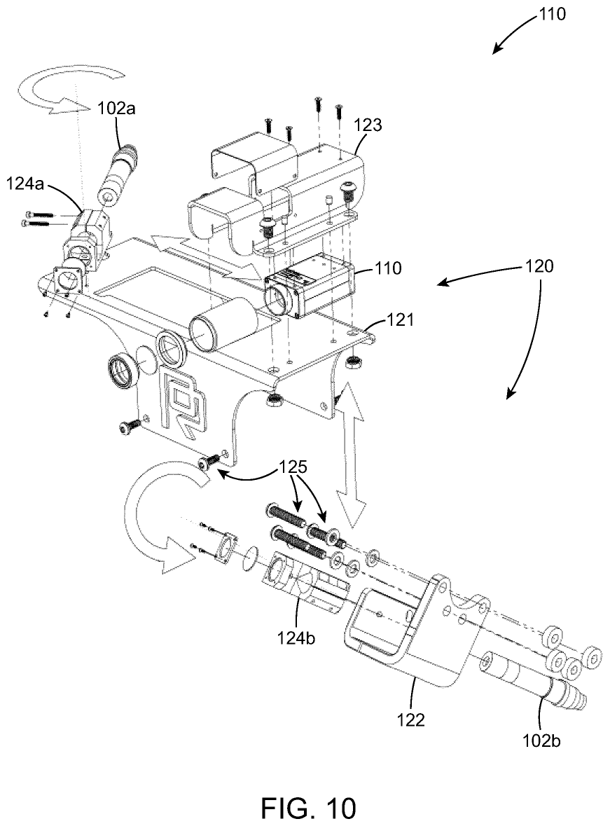

FIG. 10 illustrates how mechanical fasteners 120 may be used to mount the vision module on the 6-axis welding robot, and how some of these mechanical fasteners 120 may be adjusted to allow an adequate operation of the vision module while being mounted on the fourth axis of the 6-axis welding robot. The possible adjustments should generally allow adapting the position of the focus plane.

Of note, the adjustments of the vision module 100 may be simulated such that a user can determine, in a virtual environment, an appropriate operating and position parameters of the vision module 100 before buying hardware. Once the parameters have been tuned and determined in the simulator, they can be updated and stored in calibration files accessible for further uses.

Before installing the vision module 100 on the fourth axis of an existing 6-axis welding robot, or when manufacturing a 6-axis welding robot according to the present techniques, it is possible to simulate, in a virtual environment, the positions of the 6-axis welding robot that would allow acquiring the images for locating a welding joint. If some joints are difficult to image, a user can decide to virtually change the setup of the vision module (e.g., its position or orientation) in the virtual environment, without changing the actual configuration of the 6-axis welding robot, in order to evaluate an appropriate configuration for the vision module. It should be noted that, in the appropriate configuration, the optical plane of each optical sources 102a, 102b (e.g., the laser planes, as previously described) should intersect with the optical axis of the camera lens at the same position. Many parameters may be simulated in the virtual environment such as, for example and without being limitative, the angle of incidence of the optical sources 102a, 102b, the displacement the optical sources 102a, 102b with respect to the camera 110, and the focal length of the lens included in the camera. Of note, the components of the vision module may be displaced in the virtual environment using a graphic interface.

Once the parameters have been simulated, the adjustments can be made to the vision module of the 6-axis welding robot in real life. Once adjusted, the vision module may be configured such that the camera 110 covers a substantially square area having a side length ranging between about 30 mm and 120 mm (as exemplified in FIGS. 6a and 6b).

In some embodiments, the mechanical fasteners 120 for mounting the vision system 100 on the fourth axis of the 6-axis welding robot may include two separate supports 121, 122 detached one from each other, which may be useful in limiting the effect of contortion. Both supports 121, 122 may be attached to the robot upper arm by fastening means 125, such as, for example, bolts and screws. For instance, the first support 121 may be attached on a middle portion of the robot upper arm on the fourth axis. In some embodiments, the first support 121 may be attached to the 6-axis welding robot using two screws, each being provided on a respective side of the first support, such that the first support tightly fits around the 6-axis welding robot's upper arm (illustrated, for example, on FIG. 4). The first support may be used to hold in position one of the first and second optical sources 102a, 102b (e.g., the first laser or first optical source 102a) and the camera 110. The second support 122 may be used to hold the other one of the first and second optical sources 102a, 102b (e.g., the second laser or second optical source 102b) in position. Casings such as a camera casing 123 and optical source casings 124a, 124b may further be provided to maintain/hold and protect the camera 110 and the optical sources 102a, 102b (e.g., in the case of a collision with an element in the surrounding area which can potentially damage de optical sources 102a, 102b or the camera 110). In some embodiments, the second support 122 may be attached with eight screws, each being provided at a bottom portion of the 6-axis welding robot's upper arm. In some embodiments, the screws may be arranged in a circular configuration and evenly distributed (e.g., a screw at every 45 degrees). The second support may be firmly attached to the 6-axis welding robot's upper arm by using some of these screws (e.g., four screws).

In some embodiments, it may be desirable to increase the working distance of the camera 110 with respect to the welding joint 30. The working distance herein refers to the distance between the camera 110 and the position where the two illumination planes 114 intersect the optical axis (for instance, illustrated in FIG. 4). The working distance can be increased in two ways. The first way is by decreasing the angle of incidence of the optical sources 102a, 102b: a smaller angle will affect the intersection point of the planes with the optical axis, which may be done at the cost of a lower resolution of the topology (i.e., 3D relief) of the piece. The second way is by increasing the displacement between the camera 110 and the optical sources 102a, 102b, which would change the location of the intersection point between the planes 104, 114 and the optical axis.

In some embodiments, the working distance ranges between about 300 mm and 1000 mm. Relatively small working distances may be useful to locate butt joints at an appropriate resolution. Relatively large working distances may be useful to image welding joints inside a confined region, such as, for example and without being limitative, the interior of a tower. In addition, relatively large working distances generally increase the measurements sensitivity with respect to the small changes with the incident angle of the optical sources 102a, 102b. Changes in the incident angles of the optical sources 102a, 102b would shift where the plane 104 intersects the piece 32 and would thereby create an apparent change in height of the actual position of the welding joint 30, which may not be associated with an effective change in the height of the welding joint 30. Because of that phenomenon, the mechanical fasteners 120 including first and second supports 121, 122) through which the vision module 100 is attached to the 6-axis welding robot is relatively rigid. Of note, if a small drift in the optical sources incidence angle still occurs, the present technology allows reducing or mitigating this effect.

As it has been previously mentioned, the orientation of the tools 60 (e.g., welder) of existing solutions is generally defined and controlled using the axes 4, 5 and 6 51d, 51e, 51f of the 6-axis welding robot 50. However, the system 10 described herein includes a vision module 100 mounted on the fourth axis 51d, which greatly reduces the possible movements of the 6-axis welding robot 100. To alleviate this problem, the vision module 100 includes at least one optical source 102, which may optionally be two laser sources 102a, 102b (i.e., two optical sources) configured to emit a light beam having a spatial profile 104 resembling the shape of a line, as it has been previously presented. In some embodiments, the illumination directions of the two optical sources 102a, 102b are oriented 90 degrees one from the other. Such a configuration allows having two possible robot positions to measure one welding joint 30. In some scenarios, one of the optical planes 104 (e.g., laser planes) may intersect with the welding joint 30 at an angle of 45 degrees, which remains acceptable in some applications.

Broadly described and in reference to FIG. 3, the computing device 70 may be provided with modules (further described below), adapted to interact with the vision module 100 and the 6-axis welding robot 50. The term “module” refers to a combination of electronics and/or software components adapted to carry out a particular set of functions. In the illustrated embodiment, the computing device 70 may comprise a reception module 72, a pathing module 74 and an output module 76, with each module being operatively coupled with one another. In other embodiments, however, the computing device 70 can comprise other modules or, in other configurations, the computing device 70 may carry out on his own the different functionalities of the modules without the provision of said modules.

The reception module 72 is adapted to receive the image data generated by the camera 100 and then determine, from the image data, a welding path to be followed by the 6-axis welding robot 50 for welding the piece or portion of the piece. Accordingly, the reception module 72 may be in direct communication with the camera 110 and receive image data therefrom. The reception module can take the form of an interface (logical or physical) receiving data from the camera 110, for example. In some embodiments, the reception module 72 may further be adapted to receive input data from other sources than the camera, such as the welding robot 50 and/or external data sources who are also providing image data (e.g., another camera set in the periphery of the welding robot or other computing devices providing exemplary or reference welding paths).

The output module 74 may be further adapted to control or operate the 6-axis welding robot 50 to weld the piece according to the welding path. For instance, the output module 74 can transmit data in the form of instructions regarding the way the 6-axis welding robot 50 should operate or data corresponding to the reference welding path that the 6-axis welding robot 50 can interpret to perform the welding process (e.g., a pathing, trajectory or coordinates).

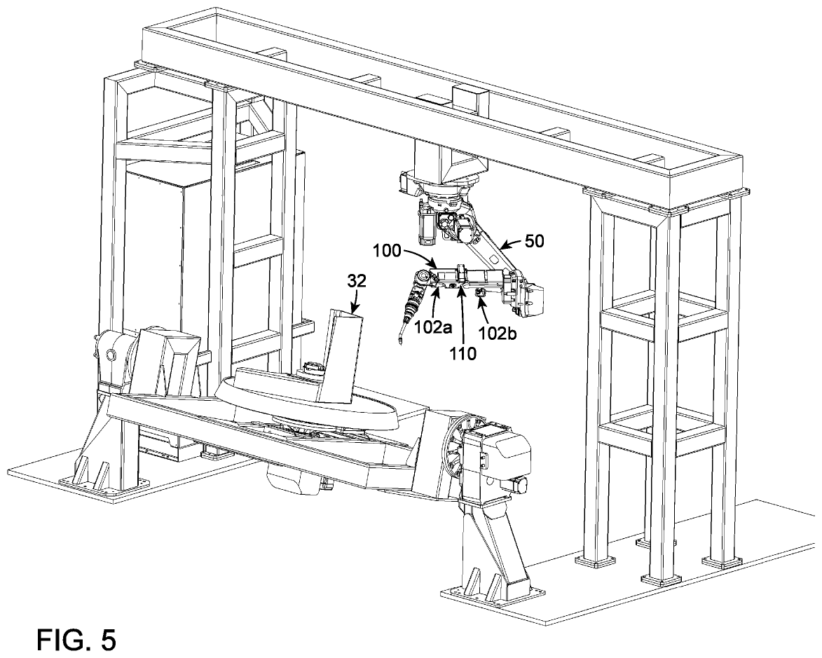

The pathing module 76 may be adapted to, based on the image data received from the reception module 74, obtain the reference welding path to be followed by the 6-axis welding robot 50. In particular, the pathing module 76 may be configured to run a software or software executable functions (in the form of packages for example) allowing simulating the whole welding process in a virtual environment, as it has already been presented. Of note, the whole 6-axis welding robot 50 (including the optical sources 102 and the camera 110) are provided in the virtual environment. FIG. 5 is an example of a virtual environment, wherein the piece 32 and the 6-axis welding robot 50 are provided. Every action or movement of the 6-axis welding robot 50 may be simulated in the virtual environment such as, for example and without being limitative, capturing an image of a piece (e.g., using an algorithm that traces rays so as to create a realistic virtual image). Simulating a step of capturing the image in the virtual environment may include calculating the path followed by the light emitted by the optical sources 102a, 102b (i.e., the light path followed by the rays forming the light beam) and being reflected by the piece, before being received by the camera 110 in the virtual environment.

Of note, the software or computer programs as described herein may be implemented in a high-level procedural or object-oriented programming and/or scripting language to communicate with a computer system. The programs could alternatively be implemented in assembly or machine language, if desired. In these implementations, the language may be a compiled or interpreted language. The computer programs are generally stored on a storage media or a device readable by a general or special purpose programmable computer for configuring and operating the computer when the storage media or device is read by the computer to perform the procedures described herein. In some embodiments, the systems may be embedded within an operating system running on the programmable computer.

In some embodiments, the computing device 70 may further be in communication with a database 78 designed to store reference images, reference data or reference points. The database 78 may be part of the programs of the computing device 70 (i.e., the database 78 may be stored in the computing device 70) or can be located at a remote location, such as a cloud system for example.

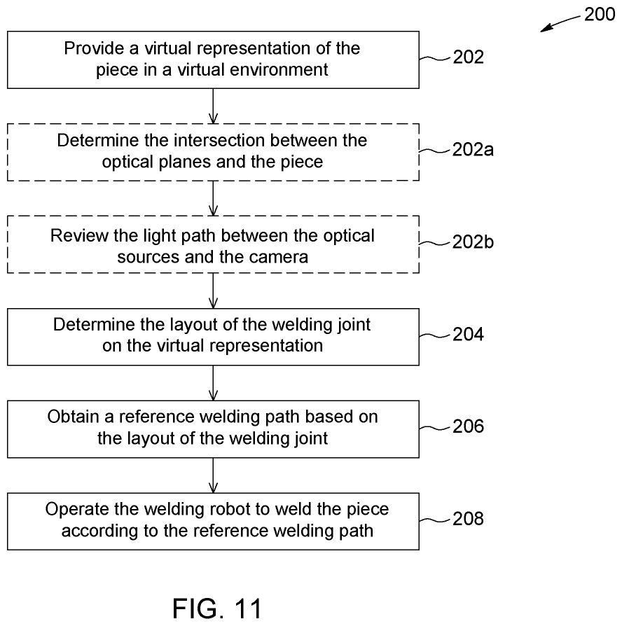

Now referring to FIG. 11, broadly described, in some embodiments, a method for welding at least a portion of a piece with a welding robot may be provided 200. the method 200 includes providing a virtual model representative of a piece to be welded in a virtual environment 202; determining a layout of a welding joint on the virtual model 204; and obtaining a reference welding path of a welding robot based on the layout of the welding joint determined on the virtual model 206. The step of obtaining the reference welding path may be embodied by a step of determining or receiving the reference welding path. A welding robot may be operated, in the virtual environment or in the physical world, to weld the at least portion of the piece in accordance with the reference welding path determined in the virtual environment 208. It should be noted that the welding robot may be embodied by a six-axis welding robot such as, or similar to, the ones described above, i.e., a six-axis welding robot including a vision module mounted on its fourth axis. Of note, the method 200 or at least some steps of the method may be used with other types of welding robots. In some embodiments, determining the layout of the welding joint 204 may include obtaining a welding path and adjusting the welding path to compensate for imperfections that may be present on the piece. In some embodiments, the welding path may be provided by an external computer program or may be created by a user, i.e., the welding path is obtained from an external source.

The step of providing a virtual model representative of the piece in a virtual environment 202 will now be presented in greater detail. Of note, this step may include obtaining, generating, calculating, or otherwise processing virtual models or virtual images in a virtual environment.

The step of providing a virtual model 202 may include receiving, obtaining or calculating a virtual reference image, by determining the light path followed by the rays (i.e., virtual representation of the rays in the virtual environment) of the light beams emitted by the optical sources. In some embodiments, the virtual reference image is generated following a two-step procedure, a nonlimitative example thereof being illustrated in FIG. 6b. In a first step 202a, the intersection between the optical planes (e.g., the laser planes) and the piece is determined. The second step 202b includes reviewing the light path between the optical sources and the camera, in order to identify any potential occlusions from other portions of the piece. Considering that the precision of industrial components is often around ±10 mm compared to their nominal layout (e.g., their CAD models), the virtual reference image generally offers an adequate approximation of what the real image of the piece would look like. Providing a virtual reference model or image 202 may be associated with several advantages and benefits. It is first possible to measure the piece to be welded and then test, in the virtual environment, how the welding routine should be performed. Obtaining the optimal welding path 206 or routine may require some adjustments, which may be entirely simulated in the environment. It can also confirm that the whole welding joint will remain in frame, i.e., that the joint can be captured by the camera when the 6-axis welding robot is operated in real life. Of note, the measurements made in the virtual environment may be associated with a tolerance of ±10 mm, which is a common tolerance for industrial pieces. This virtual characterization of the piece allows reducing the risks of encountering glitches or bugs during the welding of the piece by the 6-axis welding robot. In addition, this allows reducing the downtime of the 6-axis welding robot, as the tests are performed in the virtual environment, without requiring the access to a physical 6-axis welding robot. Of note, the virtual reference image is generally a black and white representation of the laser profile over the welding joint, which may be useful to identify a starting point of the welding joint, when trying to find the laser profile in the real pictures (i.e., outside of the simulator). As the pieces generally include many imperfections on their surface, scattering is generally observed in real images of the pieces. Other optical noise may be present in the real images as well, such as, for example and without being limitative, reflections from ceiling lights and other unpredictable phenomena affecting the ambient light. Another example of optical noise may be the second reflection of the laser light on the parts which can be redirected towards the camera or the vision module. Having access to a virtual reference image or model allows the focusing on the relevant region of the images.

In comparison, conventional vision systems that are generally provided with existing 6-axis welding robots use reference images that are taken with real cameras on actual and physical industrial pieces. As the manufacturing process of the industrial pieces is not always precise, multiple iterations are typically needed to obtain a reliable reference image. Moreover, any minor changes in the design of the industrial pieces would require new reference images and associated iterations, which can be time and resource consuming. In contrast, the present techniques allow a user to have access to an entire database storing a plurality of reference images that were obtained in the virtual environment.

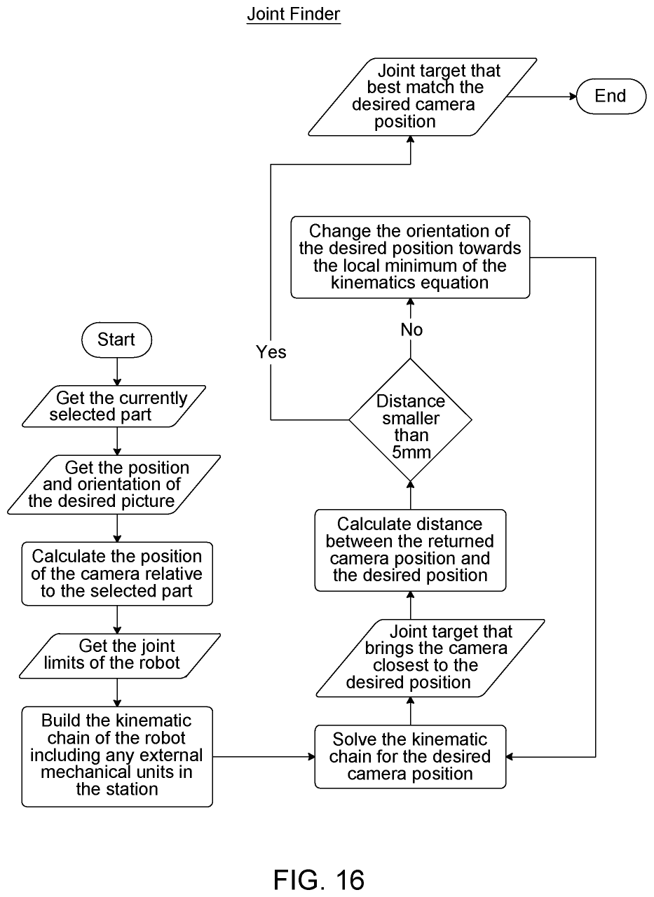

It should be noted that the use of the virtual image as a virtual reference image is associated with many benefits. For example, it allows complete offline programming of the steps of the method 200, in particular the step of determining the layout of a welding joint 204 or even locating the welding joint (as illustrated in FIG. 16), because it is simulated in the virtual environment, and so does not result in stopping an operative 6-axis welding robot for test or calibration purpose only. As such, the usual time-consuming step of acquiring reference images is replaced by a virtual reference image of the piece. Using a virtual reference image may also allow for a more precise detection of the position of the real laser profiles in the real pictures, as it will be explained in greater detail below.

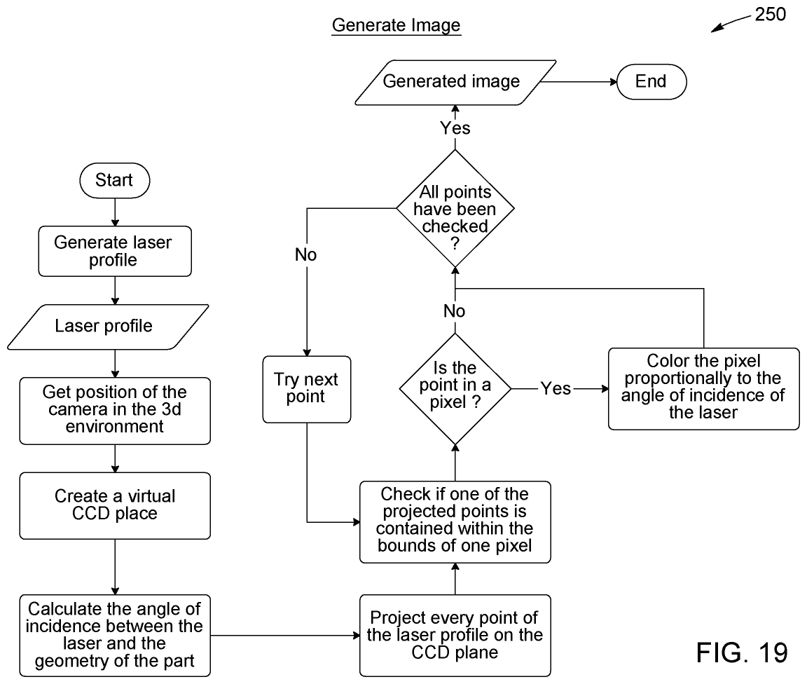

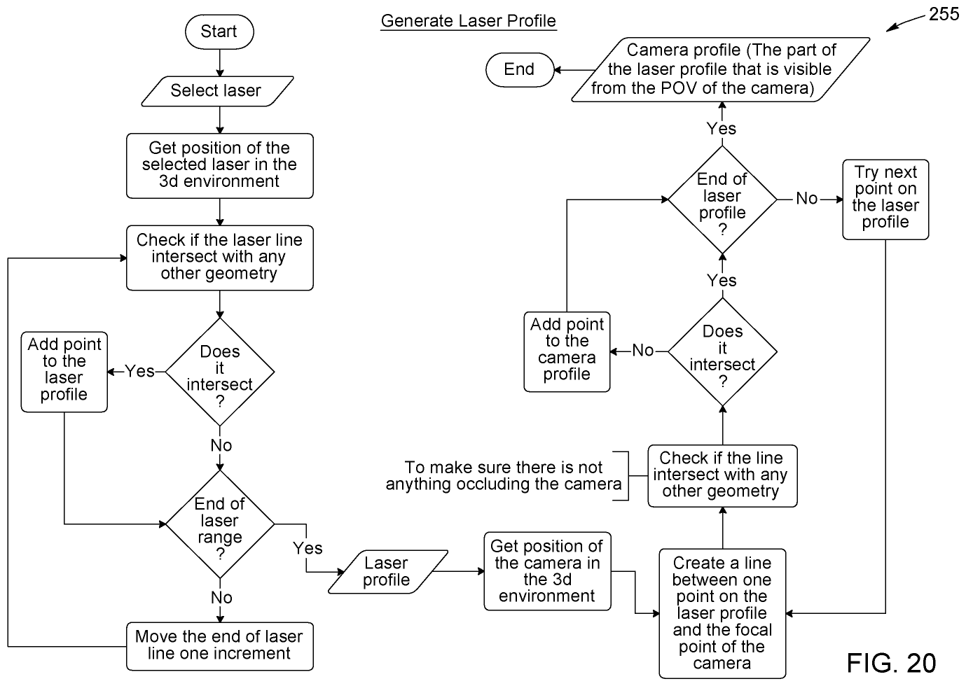

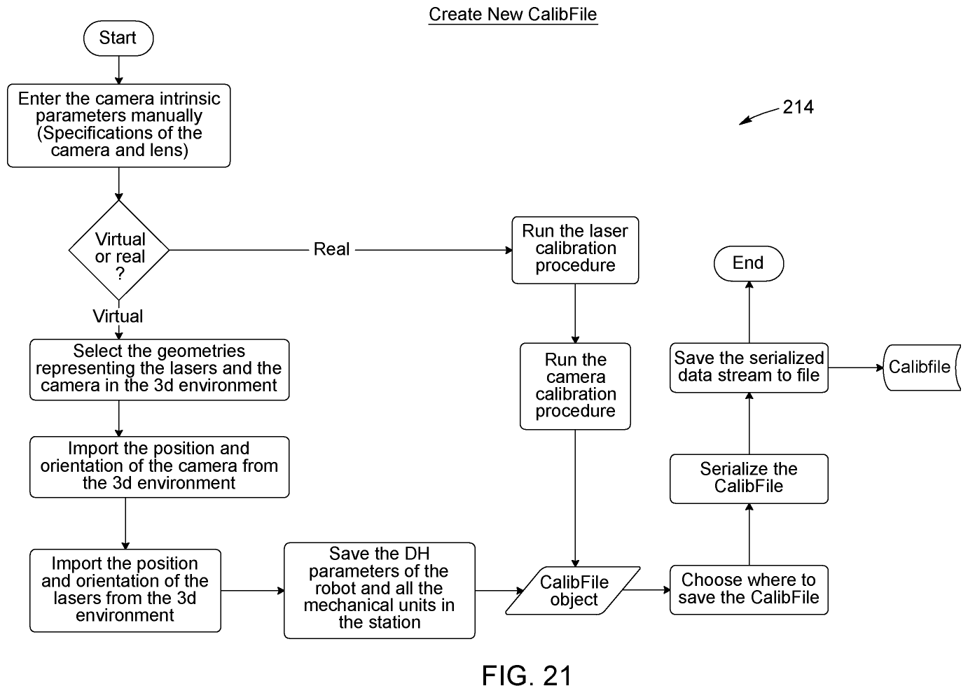

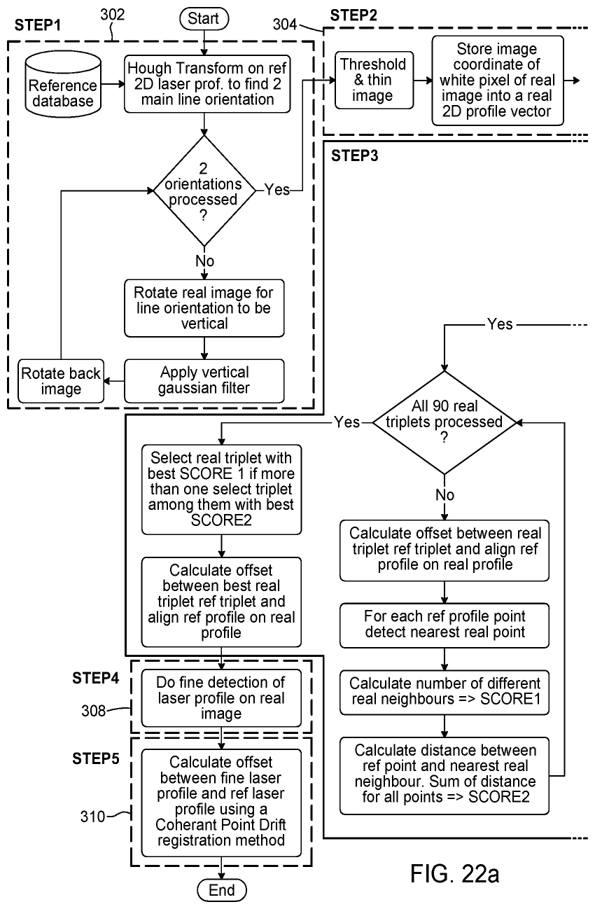

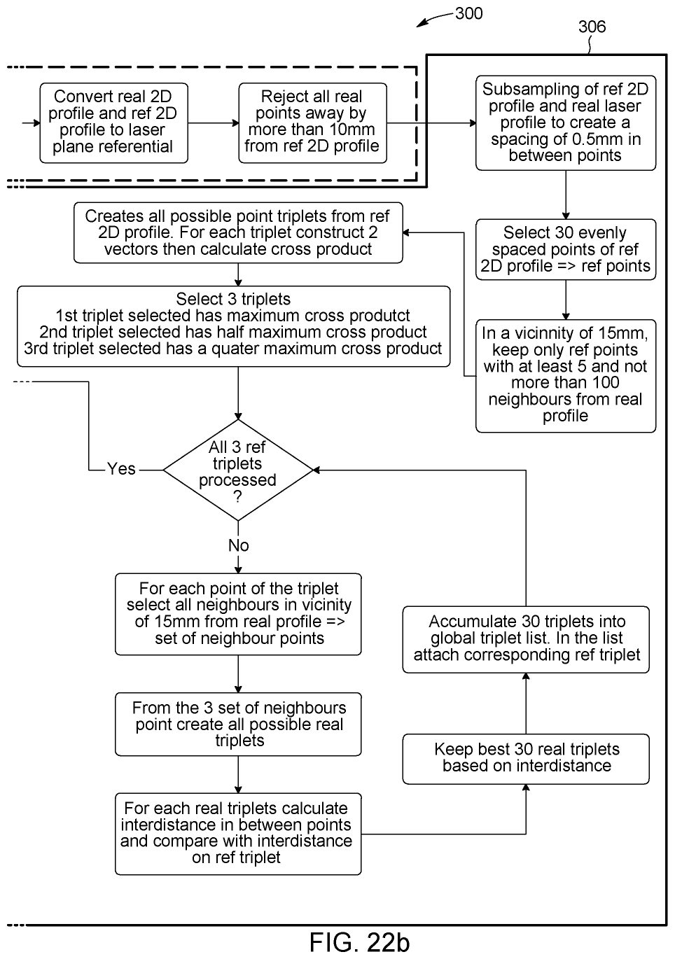

Now turning to FIG. 19, there is illustrated a method for calculating the virtual image 250, in accordance with one embodiment. The method 250 illustrated in FIG. 19 relies on another method for generating the laser profile. The method for generating the laser profile 255 is illustrated in FIG. 20. As illustrated, the first step of this method 255 is to select and activate the optical sources or lasers. The method 255 includes determining the position and orientation of the selected optical sources or lasers with respect to the fourth axis of the 6-axis welding robot from the calibration file, the details of which will be presented with greater detail below. The method 255 includes calculating, from the 6-axis welding robot position, the position and orientation of the fourth axis with respect to base (or another reference point) of the 6-axis welding robot, and then calculating the position and orientation of the optical sources with respect to the base of the 6-axis welding robot. The characterization of the position and orientation of the fourth axis, the optical sources and the camera may be used to determine a point from which the laser plane is projected. For each ray projected, a mathematical relation may be used to determine the light path in the virtual environment, and therefore identifying a point belonging to the laser profile. When all the rays have been processed, the laser profile is characterized. The method 255 includes a step of eliminating the points which cannot be seen from the camera, which may be achieved by using data contained in the calibration file. As it will be explained in greater detail below, the position and orientation of the camera with respect to the fourth axis may be stored in the calibration file. As the position and orientation of the fourth axis with respect to base are known, it is possible to calculate the position and orientation of the camera with respect to the base of the 6-axis welding robot, thus providing a point from which the laser profile is projected into the camera. For each point on the laser profile, it is possible to calculate the light path for reaching the camera center point. If the light path crosses another graphic item (belonging to the piece or to something else), then the point is considered “occluded”, and the method eliminates this point from the laser profile. Once all the occluded points have been deleted, the resulting laser profile is returned to the method for generating the virtual image, as illustrated in FIG. 21. The method for generating the virtual image includes projecting all laser profile points on the image plane and keeping only the points projected inside the CCD sensor limits. For each laser profile point, the method 250 may also include calculating the angle between the incident laser ray (or other light beam) and the light beam surface normal. On the virtual image, the light intensity of the projected point will be proportional to that angle.

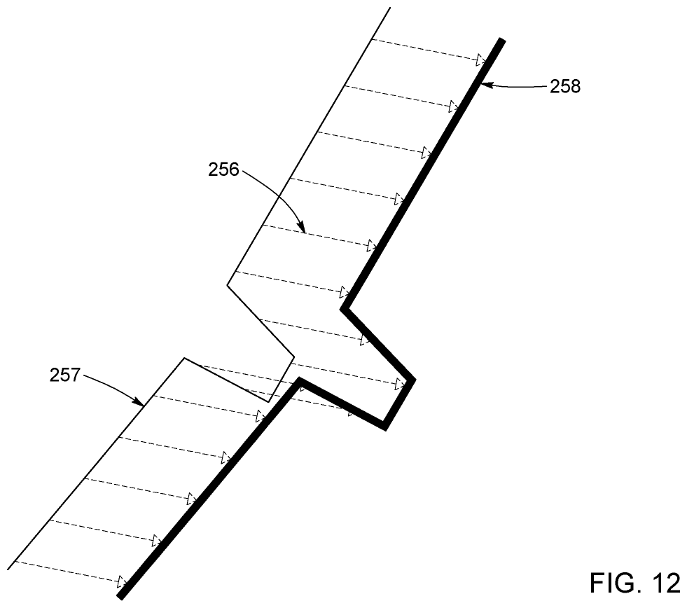

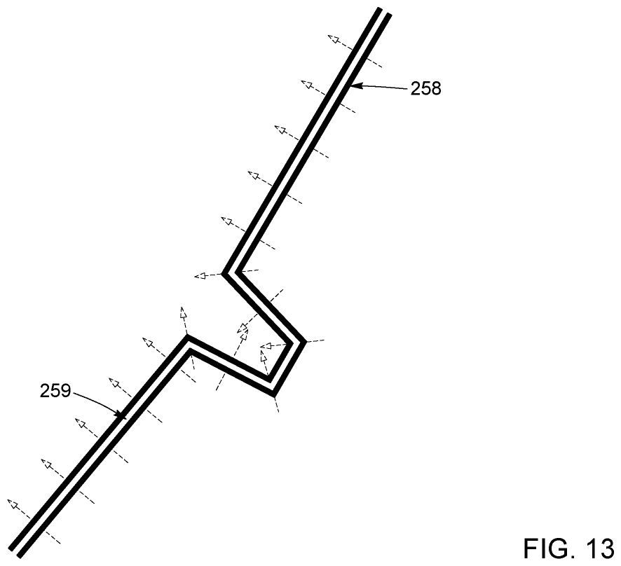

As shown in FIG. 12, the global offset 256, which is the average distance between the virtual and the real profile 257, 258, is already known, as it has been previously characterized by the image analysis procedure herein described. As such, moving the virtual profile 257 by the offset 256 would superimpose the virtual profile 257 with the real profile 258. To get a more accurate measurement of the center of the real profile 258, the luminance may be plotted on a graph, wherein the X-axis is the pixel distance perpendicular to the laser profile and the Y-axis is the luminance of each pixel. FIG. 13 shows a real laser profile 258 with small perpendicular arrows drawn on it. Those arrows represent all the different X axes as we go down the entire laser profile. By plotting the graph for each line of a vertical laser profile, it is possible to obtain a new laser profile image with a very accurate center line 259. Since every consecutive graph is very similar to the last one or at least should be, it is possible to further reduce noise in the image by averaging outlier graphs to the luminance values of the preceding and following graphs. The precision of the center line 259 detection is directly linked the luminance observed in the image. It is possible to plot more graphs than there are pixel lines in the image. This over sampling allows the method 250 to be significantly more accurate than it would otherwise be.

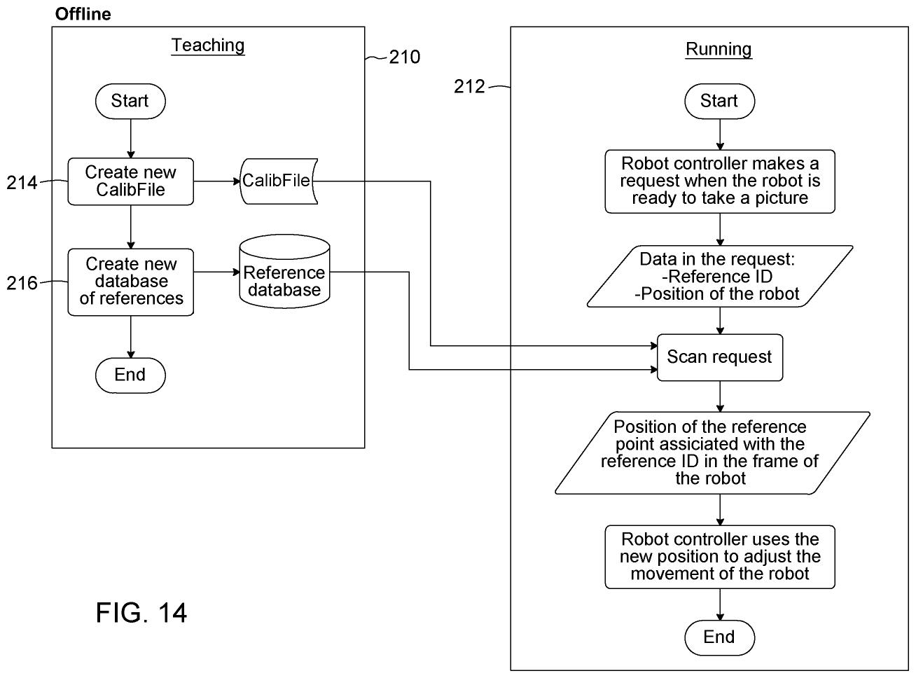

The steps of (1) providing a virtual representation of the at least portion of the piece in a virtual environment 202; (2) determining a layout of a welding joint on the virtual representation 204; and (3) obtaining a welding path of the welding robot based on the layout of the welding joint determined on the virtual representation 206 may be globally referred to as a “teaching phase” 210. The steps of operating the welding robot to weld the piece according to the determined welding path 208 or any other steps involving the operation or control the 6-axis welding robot may be referred to as a “running phase” 212. The flowchart illustrated in FIG. 14 present the teaching 212 and running phases 210.

In the teaching phase 210, the virtual image is determined or calculated at each one of the 6-axis welding robot acquisition positions. If the point of view offered at one of the acquisition positions is adequate, then the virtual image may be stored into a database. The virtual image is stored, and the information relating to the corresponding 6-axis welding robot position is also stored. The step of determining the acquisition position may be manually performed (e.g., through visual inspection), automatically performed (e.g., using computational methods), or semi-automatically performed (e.g., a combination of visual inspection and computational methods). In some embodiments, it may be relatively easy to locate and subsequently click on the reference point because the laser profile may be highlighted on the CAD model of the part. A reference point may be added to the virtual image being stored for future use. In some embodiments, the reference point may be selected by the user (e.g., by identifying the reference in the CAD file and clicking on the same). It should be noted that the reference point generally corresponds to the position at which the laser profile intersects with the welding joint.

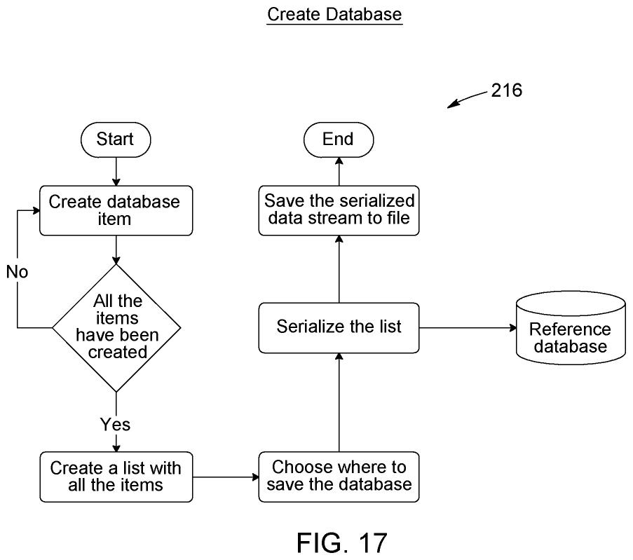

The left portion of FIG. 14 illustrates some possible steps of the teaching phase 210. As illustrated, the teaching phase 210 includes creating a calibration file containing the vision module parameters 214. It also includes creating a database containing the virtual reference images (also referred to as a reference database), reference points and the corresponding 6-axis welding robot acquisition positions 216 (illustrated in more details in FIG. 17).

The creation of the calibration file 214 is illustrated in FIG. 21. As illustrated, the creation the calibration file 214 begins with providing the intrinsic parameters (i.e., the specifications) of the camera and associated optical components (e.g., lenses). This step may be embodied by manually entering specifications in the calibration file. Of note, the specifications may include focal length, the number of pixels (height and/or width) of the CCD sensor and the physical size of each pixel. As illustrated, the creation of the calibration file 214 includes two branches: the first one is associated with the virtual calibration file and the second one is associated with the real calibration file.

In the first branch (i.e., the virtual calibration file), creating the virtual calibration file 214 may then be carried out in the virtual environment and may include selecting the geometries and parameters of the optical sources and camera being virtually provided in the virtual environment. The position and orientation of the fourth axis may be selected, which allows mathematically determining the position and orientation of the camera with respect to the fourth axis and the position and orientation of the optical sources with respect to the camera. This information (position and orientation of the fourth axis, the camera and the optical sources) may then be saved in the calibration file.

The second branch may be carried out when the 6-axis welding robot is physically implemented and ready to weld pieces. In the case of the real calibration file, a metrological grid may be placed at a convenient position that may be reached by the 6-axis welding robot. The position of the metrological grid is known with respect to the base of the 6-axis welding robot. The metrological grid may be captured by the camera and a computing step may be carried out to determine the position and orientation of the camera with respect to the metrological grid. Because the position of the fourth axis of the 6-axis welding robot is known, it is possible to calculate the position and orientation of the camera with respect to the fourth axis of the 6-axis welding robot. The camera may then be operated to obtain image or image data illustrating the intersection of the light beams and the metrological grid. The position and orientation of the camera may then be calculated with respect to the metrological grid, making it possible to locate the lines formed by the optical sources and with respect to the camera. A plurality of points of view may be acquired, which may then be used to calculate the position and orientation of the optical planes associated with the light beams generated by each optical source with respect to the camera.

Once the calibration parameters have been calculated, they may be saved in the calibration file.

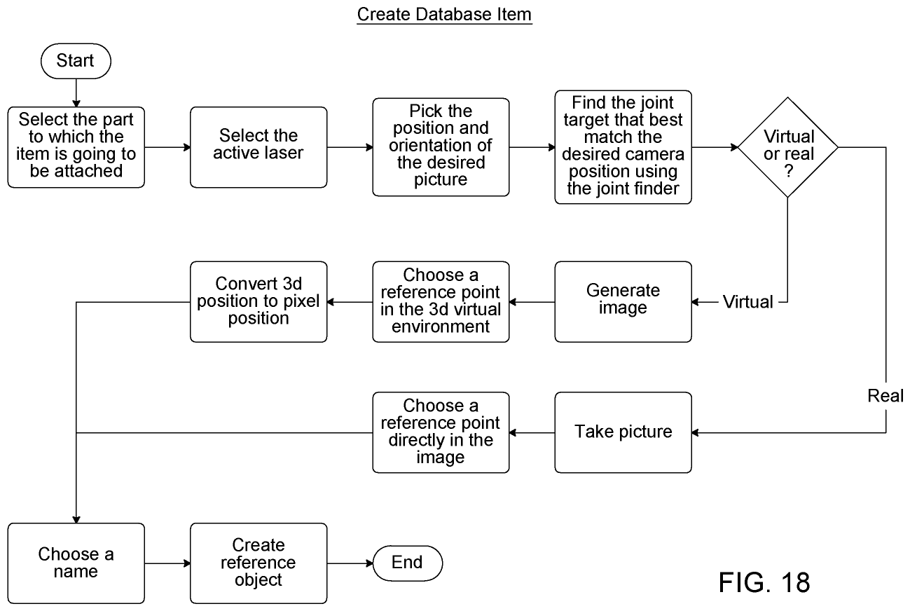

An embodiment of the creation of the database 216 containing the reference images is illustrated in FIGS. 17 and 18. As illustrated, a user may activate one of the two optical sources (e.g., a laser) and may then a point on the CAD model of the part. It is possible to determine a list of achievable 6-axis welding robot positions that allow seeing that point. The user may then select the best or an appropriate position from the list of potential positions, and then calculate the virtual image that should be obtained at that position. Again, this step may be entirely carried out in the virtual environment. More specifically, in the virtual environment, the user can see where the light beams intersect with the piece and can then select a point along the line formed on the piece. The position and orientation of this point can be determined with respect to the base of the 6-axis welding robot. Of note, the lines formed on the piece correspond to what the camera would capture, and therefore each point on that line has an equivalent on the camera. It is therefore possible to convert the point into image coordinates, and the point may become a reference point.

A reference set may include different information such as for example and without being limitative: a virtual reference image representing a laser profile as it should appear on the image; a reference profile in 2D decimal coordinates to indicate relatively precisely where the laser profile lies on the image plane; a reference profile in 3D decimal coordinates to indicate precisely where the laser profile lies on the 3D model of the part; the 6-axis welding robot joint angle during the image acquisition; the position and orientation of the camera during the image acquisition; the angles of the external axis of the positioner, if any, during the image acquisition; a profile to indicate the tangential direction on the part surface at each point on the 3d reference profile; the reference point; and/or the position and orientation of the lasers (or other optical sources).The reference set is saved in the database and is tagged with a name and a number, which may be, for example and without being limitative, specified by the user. Accordingly, the saved reference set (tagged with a name and number) is associated as a database item, as referred in FIGS. 17 and 18. Once all the database items are created and stored in an item list, the database can be saved in the database file.

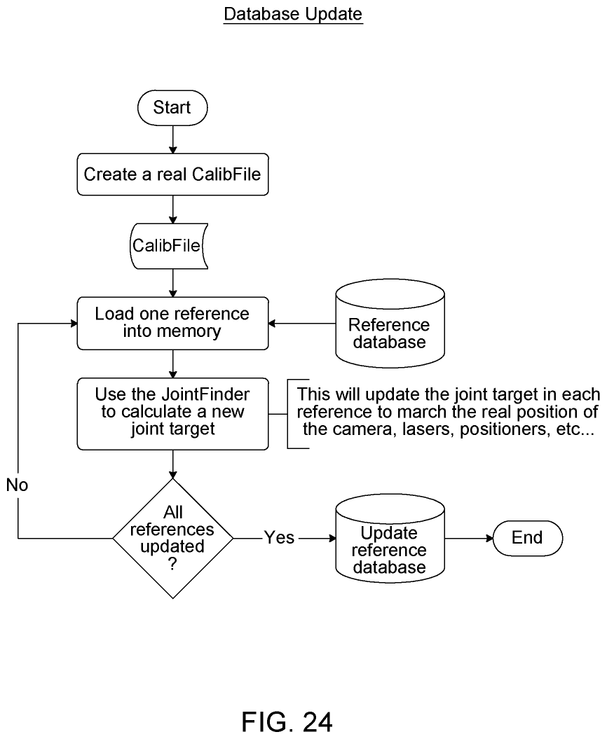

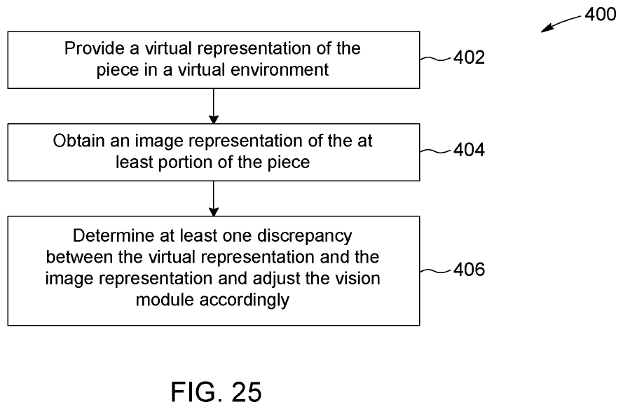

In other embodiments, a step of updating the database (i.e., updating the information or data being stored therein) can further be provided (illustrated, for example, in FIG. 24). When a recalibration or readjustment of the vision module parameters occurs, i.e., a modification or recreation of a calibration file (referred to as calibFile), the references in the database can be loaded and updated to match the new parameters of the vision module. Accordingly, the database can be up to date with the new positioning of the vision module with respect to the target joint.

Referring back to FIG. 14, after the completion of the teaching phase 210, the running phase 212 may be performed. The running phase 212 is associated with the “real operation” of the 6-axis welding robot, i.e., in the physical world, outside of the virtual environment. During the running phase 212, a real image is acquired and processed, in order to identify the laser profile. The previous acquisition of a virtual image facilitates the identification process by providing a reference for the profile shape and its position inside a zone of ±10 mm, as it has been previously presented. The method 200 may include calculating the offset between the laser profiles from the virtual model and the actual piece. The offset may be used to more precisely determining the joint location.

More specifically, the running phase 212 may be carried out when the 6-axis welding robot is in operation. When in operation, the 6-axis welding robot sends a request to a controller or a computer controlling the vision module for each image being acquired. A reference number is generated and associated with the 6-axis welding robot position. The acquired image may then be analyzed.

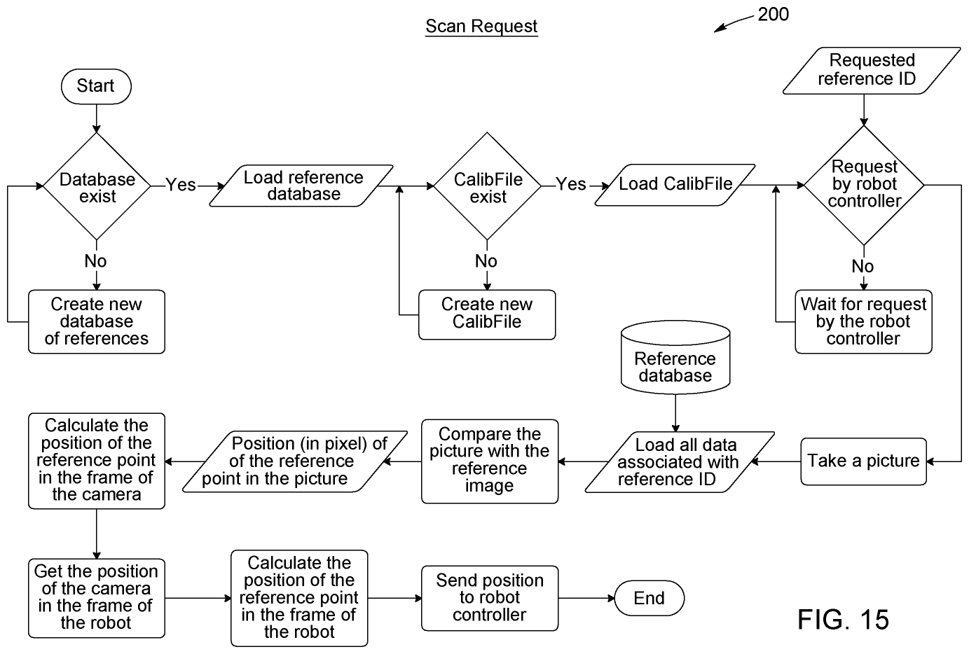

A nonlimitative embodiment of a complete method 200 is illustrated in the flowchart shown in FIG. 15. After the image acquisition, the reference image and point are fetched. The method 200 extracts the real laser profile and uses the reference image during the process. Once extracted the real laser profile is converted into 3D coordinates with respect to the base of the 6-axis welding robot in that referential system, the offset between the reference profile and the real profile is calculated and applied on the reference point so that it represents a point on the real piece. If the reference point was initially attached to the welding joint position on the virtual model of the piece, then it now corresponds to the welding joint position on the real piece. Once obtained, these 3D coordinates can be transmitted to the 6-axis welding robot to control its operation.

Advantageously, the present methods allow quickly recalculating the virtual reference images, which may be useful when small changes in the geometry of the vision module are observed, whether those small changes are voluntary or not. The calculation or recalculation of the virtual models or images may include determining a tangential direction at the surface of the piece for each point on the laser profile. The tangential direction (Ts) can be expressed as the cross product of a vector normal to the surface at a given point (Ns) and a vector tangential to the surface at the given point (Tp) of the laser profile according to the following equation:

Ts=Tp×Ns

The above equation allows correcting of the virtual reference image knowing that each point on the laser profile has to move along the surface tangent in order to cross the laser plane, whenever the latter has its geometry slightly modified. After recalibration or readjustment of any of the two laser planes, each point of the laser profile is at the intersection between the surface tangent and the adjusted laser plane (i.e., position and orientation).

Now that various aspects of the present techniques have been described, a nonlimitative embodiment of a universal method for welding a piece with a welding robot 300 will be presented.

The objective of the universal method 300 is to calculate the positions of the welding joints in the real images captured by the 6-axis welding robot. The method 300 relies on virtual images generated in a simulator. The virtual reference image is a black and white simulation of the laser profile over the 3D geometry of the welding joint. Other objectives of the universal method 300 include processing the images and returning the 3D Cartesian coordinates of the laser profile in the 6-axis welding robot's reference frame.

As previously mentioned, the accuracy of production parts is often around ±10 mm compared to their CAD models. The shape of the laser profile in the real pictures is almost identical or at least sufficiently close to the shape of the laser profile in the virtual reference images, when generated according to the present techniques. This provides a reliable preview of what the real image as captured by the vision module would look like when the 6-axis welding robot will be operated. Since the universal method relies on a virtual reference image, the user does not have to adjust the vision module on the real 6-axis welding robot when carrying out his/her tests.

Broadly described, the universal method 300 includes five steps:
1. Pre-filtering the real image to remove noise and unwanted artefacts 302, such as, for example and without being limitative, luminosity spikes and the like. Then, in accordance with the virtual reference image, region(s) wherein the laser profile should be present is enhanced (“first step”);
2. Luminosity thresholding the real image to remove any light fainter than what is expected from the laser(s) or optical source(s) 304. The objective of this step is to create a binary image wherein the white pixels are assumed to be part of the laser profile and the rest is black (“second step”);
3. Matching the shape of the real laser profile to the shape of the virtual reference profile 306. Once a match has been found, the distance between the real laser profile and the reference laser profile is measured (“third step”);
4. Analyzing the luminance signal to find the center of the real laser profile 308. The luminance signal may be shaped as a bell curve, wherein the top of the bell curve is the center of the profile (“fourth step”); and
5. Recalculating the distance between the center of the real laser profile and the virtual reference laser profile 310. The calculations may be done using an algorithm called “Coherent Point Drift registration” (“fifth step”).

Each step of the universal method 300 will now be described in greater detail.

The objective of the first step 302 is to identify two main line orientations of the virtual laser profile. This step 302 may include using a Hough transform to build a line histogram over the virtual profile. The method may then include detecting on the line histogram the two major peaks, each peak describing a line with an orientation and a distance from the origin. Only the line orientation is retained. For each of the two orientations, the method may include rotating the real image to make the corresponding line vertical, and then apply a vertical Gaussian filter (nonlimitative example of parameters: number of points=55, variance=4.25 and number of lines=11), before rotating the image to its original position. After two iterations, the image is enhanced.

The second step 304 applies a brightness threshold on the enhanced real image. Pixels over the threshold are marked as laser point candidates. The second step 304 produces a black and white image with the white pixels being the laser points. It is then possible to apply a thinning operation on the black and white image to reduce the laser points to a thin line of one pixel thick. After this operation, the set of laser points is reduced, and the method identify the image coordinates and records the same in a vector called the real laser profile. The vector format is the one used for the reference laser profile. Both the real and reference profile point coordinates are converted into the laser plane reference system. In this reference system, the scaling is metric and undistorted with respect to the 3D world. An advantage with this approach is that laser points which come from a 2^{nd} reflection of the laser light on the piece tend to move away from the reference profile. The laser points from a 2^{nd} reflection do not satisfy the assumption that laser points are part of the laser plane. When these points are mapped back to the laser plane, they are inconsistent with the shape of the laser profile. In the laser plane reference, the method 300 includes eliminating all real laser points which are away from the laser reference profile by more than 10 mm.

The objective of the third step 306 is to identify the shape on the real laser profile that corresponds to the shape of the reference laser profile. The recognition of the shape is done initially by selecting a set of three points (a triplet) which best or appropriately characterizes the reference profile. Then, the corresponding triplet is located on the real profile. If the recognition is properly done, it is possible to establish the offset between the real and reference profiles as being the offset between the two triplets. This recognition step will now be described. First, both the reference and real profiles are under sampled to have a gap of about 0.5 mm between points. Next, 30 points are selected on the reference profile. The 30 points are generally evenly spaced. The method 300 includes a step of eliminating the points which having less than five neighbors from the real profile at a distance less than 15 mm. The method 300 also includes eliminating points which have more than 100 neighbors from the real profile at a distance less than 15 mm. The set of reference points being reduced, it is then possible to establish a list of all possible triplets. For each triplet, two vectors are determined, and the cross product between those two vectors is calculated. The cross product is a good criterion for selecting points far apart from each other that are not collinear together. Three triplets may be selected based on the magnitude of the cross product. The first triplet has the highest magnitude, the second triplet has a magnitude which is half the first triplet, and the third triplet has a magnitude which is a quarter of the first triplet. For each of the three reference triplets, a list of all neighbors on the real profile which are less than 15 mm away is determined, resulting in three sets of points, one for each triplet point. The method 300 then includes creating a list of all possible real triplets having a point in each set. From that list, it is possible to select 30 triplets whose inter-distance in between points are the most similar to the reference triplet. Inter-distance is a simple, yet robust criterion for recognizing a shape. The same sequence may be applied to the two other reference triplets. Each time, a new list of 30 real triplets is constructed. At the end, there are three lists of 30 real triplets, one list for each of the three reference triplets.

For each list and for each triplet, the offset between the real triplet and the corresponding reference triplet may be calculated. The offset is then applied to align the reference profile over the real profile. After the alignment, the method 300 includes identifying the nearest neighbor on the real profile for each reference point. For instance, this step may include evaluating all neighbors found in a given region and counting how many are different. As an example, if the alignment is unsatisfactory, many reference points will select the same real point which is at the extremity of the real profile, thus reducing the count of different neighbors found. Another objective of this step of the universal method 300 is to determine which triplets have the highest number of different nearest neighbors. In the case where many real triplets have the same number of different nearest neighbors, the method 300 may include selecting the triplet having an alignment producing the smallest accumulated error. The accumulated error is the summation of distances between reference points and their nearest neighbors. The triplet selected on the real profile is assumed to be the one which best or most appropriately represents the reference triplet. The offset between the two triplets is converted back to the image plane to shift accordingly the reference profile in the image plane. As a result, the reference profile will overlap the real profile. The position of the laser profile on the real image is known at an accuracy of ±1 pixel. Outliers belonging to a second reflection of laser light or belonging to surrounding noise may be easily identified and filter from the real laser profile, because they would be too far away from the reference profile.

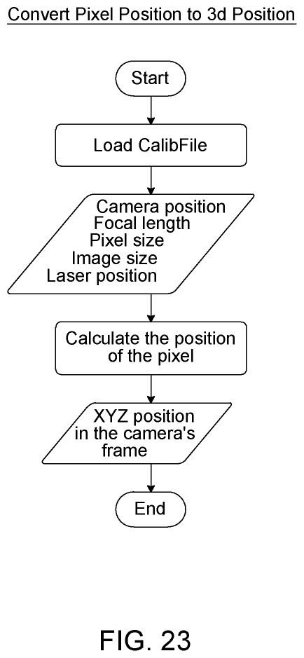

The objective of the fourth step 308 is to relocate the laser profile on the real image, now that the position of the laser profile on the real image is known with an accuracy of ±1 pixel. Once the reference profile overlaps the real image region, a line segment centered at each point on the reference profile and with a direction perpendicular to the profile at that point may be identified or calculated. There are as many segments as there are points on the reference profile. A set of points with a spacing in between them of 0.2 pixel is provided on each segment. These points are image coordinates where to interpolate luminance value on the real image. Next, the interpolated values are assigned to the points on the segment to make line image at an adequate resolution. All the line images are stacked together vertically to produce a rectified image showing the laser profile roughly in the middle of the image and in a vertical fashion. The step may include convolving a window on the rectified image to accentuate the laser profile. And may rely on using a vertical Gaussian filter having, for example, the following parameters: number of points =55, variance =4.25 and number of lines =11. After the processing steps having been described above, the detection of the points is relatively straightforward, because they should correspond to points with maximum brightness along each line of the rectified image. The coordinates of laser point having been detected may be retraced on the original image, and for example be expressed as decimal numbers representing subpixel resolution. With the use of the calibration file, the laser point coordinates can be converted in 3D coordinates with respect to the base of the 6-axis welding robot (FIG. 23 illustrates an embodiment of such example). The accuracy associated with these 3D coordinates is ±0.1 mm.

The fifth step 310 recalculates the offset between the real and reference profile in the 3D coordinates system with respect to the base of the robot. The precise localization of the real profile has also produced a real profile clean of outliers. The offset calculation can now be done with a procedure called “Coherent Point Drift registration”. The calculated offset is accurate at ±0.1 mm.

As presented above, the universal method 300 aims at determining the offset between the reference and real laser profile in two successive estimations. At first, the method 300 determines where the profile is on the real image inside a window of ±10 mm. Based on the real image, the universal method 300 may include a step of extracting the laser points and calculating the offset with an accuracy of ±1 pixel (usually ±0.5 mm). Once this is done, the position and orientation of the profile on the image is known. The universal method 300 relies on this information to set up an optimal image processing operation, allowing to obtain a relatively good detection of the center points across the laser profile, corresponding to the laser points. The offset calculated with the universal method 300 has an accuracy of ±0.1 mm.

In accordance with one aspect, there is provided a method for adjusting a vision module of a system for welding a piece or at least a portion of a piece 400. The system can comprise a 6-axis welding robot, such as the one previously presented. The method may include providing a virtual representation of the piece (or portion of the piece) to be welded 402, i.e., providing a virtual representation may correspond to a virtual model of the piece; obtaining an image representation of the piece (or portion of the piece) with the vision module, the vision module can be mounted on a fourth axis of the 6-axis welding robot (such as previously presented) 404; and determining at least one discrepancy between the obtained image and the virtual representation 406. Upon determination of discrepancy between the virtual representation and the image, the method may include adjusting an operation of the vision module in the system based on the discrepancy with respect to the piece or portion of the piece. It should be noted that a discrepancy here, may be referred to a mismatch or a lack of compatibility between certain elements of the compared virtual representation and obtained image representation.

When considering the adjustment of the system, i.e., a system for welding a piece including a 6-axis welding robot, a vision module and a computing device comprising a processor and associated memory, it should be noted that the position and orientation of the vision module and a positioner (not shown) may be adjusted (or in different terms calibrated). This adjustment may be made in the virtual environment or on the physical system (e.g., before, during or after the welding process of the real part). Of note, the position and orientation of the base of the 6-axis welding robot generally does not need to be adjusted, as the position and orientation of the base is, by definition, the origin of the 6-axis welding robot.

In accordance with one aspect, there is provided another method for adjusting a vision module of a system for welding a piece. When the position of the vision module or the positioner is changed in the virtual environment, the vision module will image a different portion of the piece. The position of the 6-axis welding robot may need to be corrected, so that the reference positions remain in the field of view of the vision module. Otherwise, errors in the calculation of the offset between the welding joint of the virtual representation, for instance the virtual model (provided in the virtual environment), and the welding joint of the real piece would be generated. In some embodiments, the position and/or orientation of the positioner may be changed to compensate for the change in the position of the vision module or the position. For example, the positioner may be associated with two motors allowing relative movements about two external axes. The positioner could alternatively be associated with one motor associated with one external axis.

Providing one or two degrees of freedom to the positioner may therefore help in calibrating the position of the vision module of the 6-axis welding robot. In some embodiments, the calibration may not rely on adding degrees of freedom to the positioner. Readjusting the image acquisition position to maintain the reference point in the laser plane may include aligning the vertical axis of the laser plane with the bisector of the angle formed by the two sides of the joint to be welded, such that they are parallel.

In some embodiments, the adjustment method 400 may include, as part of the determination of at least one discrepancy 406, calculating a mismatch between the position of the welding joint in the virtual environment (i.e., a virtual position of the welding joint) and the real position of the welding joint (i.e., in the physical environment). In some embodiments, the calculated mismatch may be used to correct the virtual model of the welding joint in the virtual environment. In some embodiments, the calculated mismatch may be used to correct the position and orientation of the welder or the vision module of the 6-axis welding robot. In both embodiments, calculating the mismatch between the virtual position and the real position may be useful to evaluate if the properties of the virtual model and the piece are within the required tolerances for industrial applications.

In accordance with another aspect of the present description, there is provided a non-transitory computer readable storage medium having stored thereon computer executable instructions that, when executed by a processor, cause the processor to perform the methods that have been previously described. The non-transitory computer storage medium can be integrated to the systems or assemblies that have been described in the present description. The non-transitory computer storage medium could otherwise be operatively connected with the systems or assemblies. In the present description, the terms “computer readable storage medium” and “computer readable memory” are intended to refer to a non-transitory and tangible computer product that can store and communicate executable instructions for the implementation of various steps of the methods disclosed herein. For instance, the computer readable medium may store computer readable instructions to perform the adjustment method, the welding method and/or the universal welding method, such as previously described, or at least one of the steps of these methods. The computer readable memory can be any computer data storage device or assembly of such devices, including random-access memory (RAM), dynamic RAM, read-only memory (ROM), magnetic storage devices such as hard disk drives, solid state drives, floppy disks and magnetic tape, optical storage devices such as compact discs (CDs or CDROMs), digital video discs (DVD) and Blu-Ray™ discs; flash drive memory, and/or other non-transitory memory technologies. A plurality of such storage devices may be provided, as can be understood by those skilled in the art. The computer readable memory may be associated with, coupled to, or included in a computer or processor configured to execute instructions contained in a computer program stored in the computer readable memory and relating to various functions associated with the computer.

Now that several embodiments of the present techniques have been presented, some of the advantages or benefit of the technology will be discussed.

The present technology facilitates the use of computer-assisted vision modules in the context of industrial applications, and more specifically in the field of industrial robotic welding applications. The techniques having been presented are generally faster and more accurate than existing solutions for detecting the positions of welding joints.

In existing solutions, it is required to physically contact the piece being welded with the welding wire or with the cup of the welder in order to determine the position of the welding joint or maintain a specific alignment with respect to the welding joint. It is estimated that detecting welding joints by physically touching the pieces being welded represents about one third of the time necessary to complete the welding process. In contrast, in the present technology, detecting the welding joints using the vision module which has been described represents only about 5% of the time necessary to complete the welding process. For example, a production cycle that would take approximately 60 minutes using the techniques from prior art (e.g., physical touching the piece as it is being welded) would take only about 42 minutes with the current technology. Moreover, physically touching a piece has a relatively limited precision of about 0.2 mm. Using a vision module as it has been herein described allows reaching a precision (or a resolution) of about 0.02 mm, which is about one order of magnitude more precise than existing solutions.

The proposed solutions would increase productivity of the users, which would in turn increase their competitiveness. The productivity of the users would also be increased, thanks to the virtual environment allowing for 100% simulated testing.

Using a reference image allows the vision module to determine how a piece would look under the camera in a virtual environment. The users could therefore visualize the piece before even buying a camera. As such, the proposed technology could also be useful in selecting and buying appropriate equipment or components for 6-axis welding robot.

As it has been previously mentioned, the method for locating the position of the welding joints and determining the welding path or trajectory may be determined in a virtual environment, which allows the users to design, program and test their entire application from their computer. The techniques having been presented may be implemented in software or be provided as plug-ins, structured as an extension to an existing robot simulator and thus expands its capabilities.

Several alternative embodiments and examples have been described and illustrated herein. The embodiments described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. The present examples and embodiments, therefore, are to be considered in all respects as illustrative and not restrictive. Accordingly, while specific embodiments have been illustrated and described, numerous modifications come to mind without significantly departing from the present disclosure.

1. A system for welding at least a portion of a piece, the system comprising:
a 6-axis welding robot, the 6-axis welding robot comprising a robotized arm, the robotized arm having first to sixth axes;
a vision module mounted on a fourth axis of the robotized arm, the vision module comprising:
at least one optical source operable to irradiate the at least portion of the piece along at least two different irradiation paths; an
a camera configured to receive light emanating from the at least portion of the piece irradiated by the at least one optical source and generate image data representative of the at least portion of the piece; and
a computing device, operatively connected to the camera, the computing device comprising non-transitory computer readable storage medium having stored thereon computer executable instructions that, when executed by a processor, cause the processor to:
receive the image data generated by the camera;
obtain a reference welding path to be followed by the 6-axis welding robot, based on the image data; and
send instructions to the 6-axis welding robot to weld the at least portion of the piece according to the reference welding path.

2. The system according to claim 1, wherein the vision module comprises at least one profilometer.

3. The system according to claim 1, wherein the at least one optical source comprises a first optical source and a second optical source, wherein the first optical source is configured to irradiate a first irradiation path of the at least two irradiation paths and the second optical source is configured to irradiate a second irradiation path of the at least two irradiation paths.

4. The system according to claim 3, wherein the first optical source is a first laser source.

5. The system according to claim 3 or 4, wherein the second optical source is a second laser source.

6. The system according to any one of claims 3 to 5, wherein the first optical source is configured to emit a first light beam and the second optical source is configured to emit a second light beam, the first light beam having a first spatial profile and the second light beam having a second spatial profile, the first spatial profile and the second spatial profile being line shaped.

7. The system according to claim 6, wherein the first light beam is associated with a first illumination plane and the second light beam is associated with a second illumination plane, the camera being configured to receive a projection of an intersection of the first illumination plane, the second illumination plane, and the at least portion of the piece.

8. The system according to any one of claims 1 to 7, wherein the image data representative of the at least portion of the piece conveys information about a location of at least one welding joint.

9. The system according to any one of claims 1 to 8, wherein the instructions cause a relative movement between the robotized arm and the at least portion of the piece.

10. The system according to any one of claims 1 to 9, wherein receiving the image data comprises acquiring the image data.

11. The system according to any one of claims 1 to 10, wherein the camera has a substantially square field of view, the field of view having a side length ranging from about 30 mm to about 120 mm

12. The system according to any one of claims 1 to 11, further comprising mechanical fasteners configured to mount the vision module on the fourth axis of the robotized arm.

13. The system according to claim 12, wherein the mechanical fasteners comprise:
a first support, the first support being provided on a middle portion of an upper arm of the robotized arm associated with the fourth axis, the first support being configured to hold the camera and one of the first optical source and the second optical source; and
a second support provided on a bottom portion of the upper arm of the robotized arm associated with the fourth axis, the second support being configured to hold a remaining one of the first optical source and the second optical source.

14. The system according to any one of claims 1 to 13, wherein the camera has a working distance ranging between 300 mm and 1000 mm.

15. The system according to claim 14, wherein the working distance is adjustable.

16. The system according to any one of claims 1 to 15, wherein the computing device is operatively connected to a database adapted to store at least one of reference images, reference data and reference points.

17. A method for adjusting a vision module of a system for welding at least a portion of a piece, the system comprising a 6-axis welding robot, the method comprising:
providing a virtual representation of the at least a portion of the piece to be welded;
obtaining an image representation of the at least portion of the piece with a vision module, the vision module being mounted on a fourth axis of the 6-axis welding robot; and
determining at least one discrepancy between the virtual representation and the obtained image representation of the at least portion of the piece, and upon determination of a discrepancy between the virtual representation and the image representation, adjusting an operation of the vision module with respect to the at least portion of the piece.

18. The method according to claim 17, wherein said obtaining the image representation comprises acquiring the visual representation of the at least portion of the piece.

19. The method according to claim 17 or 18, further comprising:
irradiating the at least portion of the piece with a first light beam produced with a first optical source, the first light beam being associated with a first illumination plane;
irradiating the at least portion of the piece with a second light beam produced with a second optical source, the second light beam being associated with a second illumination plane.

20. The method according to claim 19, further comprising imaging an intersection of the first illumination plane, the second illumination plane, and the at least portion of the piece.

21. The method according to any one of claims 17 to 20, further comprising adjusting a working distance of the camera.

22. The method according to any one of claims 17 to 21, wherein determining at least one discrepancy between the virtual representation and the obtained image representation of the at least portion of the piece comprises calculating a mismatch between a virtual position of a welding joint in a virtual environment and a real position of the welding joint in a physical environment.

23. The method according to any one of claims 17 to 22, further comprising adjusting at least one of a position and an orientation of the at least one optical source with respect to the at least portion of the piece.

24. The method according to any one of claims 17 to 23, wherein said providing the virtual representation of the at least a portion of the piece to be welded comprises determining a virtual image representation of a laser profile across a welding joint of the at least portion of the piece.

25. The method according to claim 24, further comprising readjusting an image acquisition position to maintain a reference point in a laser plane, said readjusting the image acquisition position comprising aligning a vertical axis of the laser plane with a bisector of an angle formed by at least two sides of the welding joint of the at least portion of the piece, such that the vertical axis is substantially parallel to the bisector of the angle.

26. A method for welding at least a portion of a piece with a welding robot, the method comprising:
providing a virtual representation of the least portion of the piece to be welded in a virtual environment;
determining a layout of a welding joint on the virtual representation;
obtaining a reference welding path of the welding robot based on the layout of the welding joint on the virtual representation; and
operating the welding robot to weld the least portion of the piece according to the determined reference welding path.

27. The method according to claim 26, wherein said providing the virtual representation comprises obtaining, generating, calculating or processing virtual models or virtual images.

28. The method according to claim 26 or 27, wherein said providing the virtual representation is based on a virtual reference image.

29. The method according to claim 28, further comprising calculating the virtual reference image.

30. The method according to claim 29, wherein said calculating the virtual reference image comprises determining a tangential direction (Ts) at a surface of the at least portion of the piece, the tangential direction being expressed as a cross product of a vector normal to the surface at a given point (Ns) and a vector tangential to the surface at the given point (Tp) of the laser profile, according to the following equation:
Ts=Tp×Ns

31. A system for welding at least a portion of a piece, the system comprising:
a 6-axis welding robot, the 6-axis welding robot comprising:
a robotized arm, the robotized arm having first to sixth axes; and
a welder mounted to the robotized arm;
a vision module mounted on a fourth axis of the robotized arm, the vision module comprising:
at least one optical source operable to irradiate the at least portion of the piece along an irradiation path;
a camera configured to capture light emanating from the at least portion of the piece irradiated by the at least one optical source and generate image data;
a computing device, operatively connected to the camera, the computing device comprising:
a reception module adapted to receive the image data generated by the camera;
a pathing module adapted to obtain a reference welding path to be followed by the 6-axis welding robot, based on the image data; and
an output module adapted to send instructions to the welding robot to weld the at least portion of the piece according to the reference welding path.

32. The system according to claim 31, wherein the vision module comprises at least one profilometer.

33. The system according to claim 31 or 32, wherein the at least one optical source comprises a first optical source and a second optical source, wherein the first optical source is configured to irradiate a first irradiation path of the at least two irradiation paths and the second optical source is configured to irradiate a second irradiation path of the at least two irradiation paths.

34. The system according to claim 33, wherein the first optical source is a first laser source.

35. The system according to claim 33 or 34, wherein the second optical source is a second laser source.

36. The system according to any one of claims 33 to 35, wherein the first optical source is configured to emit a first light beam and the second optical source is configured to emit a second light beam, the first light beam having a first spatial profile and the second light beam having a second spatial profile, the first spatial profile and the second spatial profile being line shaped.

37. The system according to claim 36, wherein the first light beam is associated with a first illumination plane and the second light beam is associated with a corresponding second illumination plane, the camera being configured to receive a projection of an intersection of the first illumination plane, the second illumination plane, and the at least portion of the piece.

38. The system according to any one of claims 31 to 37, wherein the image data representative of the at least portion of the piece conveys information about a location of at least one welding joint.

39. The system according to any one of claims 31 to 38, wherein the instructions cause a relative movement between the robotized arm and the at least portion of the piece.

40. The system according to any one of claims 31 to 39, wherein receiving the image data comprises acquiring the image data.

41. The system according to any one of claims 31 to 40, wherein the camera has a substantially square field of view, the field of view having a side length ranging from about 30 mm to about 120 mm.

42. The system according to any one of claims 31 to 41, further comprising mechanical fasteners configured to mount the vision module on the fourth axis of the robotized arm.

43. The system according to claim 42, wherein the mechanical fasteners comprise:
a first support, the first support being provided on a middle portion of an upper arm of the robotized arm associated with the fourth axis, the first support being configured to hold the camera and one of the first optical source and the second optical source; and
a second support provided on a bottom portion of the upper arm of the robotized arm associated with the fourth axis, the second support being configured to hold a remaining one of the first optical source and the second optical source.

44. The system according to any one of claims 41 to 43, wherein the camera has a working distance ranging between 300 mm and 1000 mm

45. The system according to claim 44, wherein the working distance is adjustable.

46. The system according to any one of claims 31 to 45, wherein the computing device is operatively connected to a database adapted to store at least one of reference images, reference data and reference points.

47. A non-transitory computer readable-storage medium having stored thereon computer readable instructions for adjusting a vision module of a system for welding at least a portion of a piece, the system comprising a 6-axis welding robot, the instructions causing one or more processors to perform a method, the method comprising:
providing a virtual representation of the at least a portion of the piece to be welded;
obtaining an image representation of the at least portion of the piece with a vision module, the vision module being mounted on a fourth axis of the 6-axis welding robot; and
determining at least one discrepancy between the virtual representation and the obtained image representation of the at least portion of the piece, and upon determination of a discrepancy between the virtual representation and the image representation, adjusting an operation of the vision module with respect to the at least portion of the piece.

48. The non-transitory computer readable-storage medium according to claim 47, wherein said obtaining the image representation comprises acquiring the visual representation of the at least portion of the piece.

49. The non-transitory computer readable-storage medium according to claim 47 or 48, wherein the method further comprises:
irradiating the at least portion of the piece with a first light beam produced with a first optical source, the first light beam being associated with a first illumination plane;
irradiating the at least portion of the piece with a second light beam produced with a second optical source, the second light beam being associated with a second illumination plane.

50. The non-transitory computer readable-storage medium according to claim 49, wherein the method further comprises imaging an intersection of the first illumination plane, the second illumination plane, and the at least portion of the piece.

51. The non-transitory computer readable-storage medium according to any one of claims 47 to 50, wherein the method further comprises adjusting a working distance of the camera.

52. The non-transitory computer readable-storage medium according to any one of claims 47 to 51, wherein determining at least one discrepancy between the virtual representation and the obtained image representation of the at least portion of the piece comprises calculating a mismatch between a virtual position of a welding joint in a virtual environment and a real position of the welding joint in a physical environment.

53. The non-transitory computer readable-storage medium according to any one of claims 47 to 52, wherein the method further comprises adjusting at least one of a position and an orientation of the at least one optical source with respect to the at least portion of the piece.

54. The non-transitory computer readable-storage medium according to any one of claims 47 to 53, wherein said providing the virtual representation of the at least a portion of the piece to be welded comprises determining a virtual image representation of a laser profile across a welding joint of the at least portion of the piece.

55. The non-transitory computer readable-storage medium according to claim 54, further comprising readjusting an image acquisition position to maintain a reference point in a laser plane, said readjusting the image acquisition position comprising aligning a vertical axis of the laser plane with a bisector of an angle formed by at least two sides of the welding joint of the at least portion of the piece, such that the vertical axis is substantially parallel to the bisector of the angle.

56. A non-transitory computer readable-storage medium having stored thereon computer readable instructions for welding at least a portion of a piece with a welding robot, the instructions causing one or more processors to perform a method, the method comprising:
providing a virtual model of the least portion of the piece to be welded in a virtual environment;
determining a layout of a welding joint on the virtual model;
obtaining a reference welding path of the welding robot based on the layout of the welding joint on the virtual model; and
operating the welding robot to wield the least portion of the piece according to the determined reference welding path.

57. The non-transitory computer readable-storage medium according to claim 56, wherein said providing the virtual representation comprises obtaining, generating, calculating or processing virtual models or virtual images.

58. The non-transitory computer readable-storage medium according to claim 56 or 57, wherein said providing the virtual representation is based on a virtual reference image.

59. The non-transitory computer readable-storage medium according to claim 58, further comprising calculating the virtual reference image.

60. The non-transitory computer readable-storage medium according to claim 59, wherein said calculating the virtual reference image comprises determining a tangential direction (Ts) at a surface of the at least portion of the piece, the tangential direction being expressed as a cross product of a vector normal to the surface at a given point (Ns) and a vector tangential to the surface at the given point (Tp) of the laser profile, according to the following equation:
TS=Tp×Ns

61. A method for assisting a welding process of at least a portion of a piece with a welding robot, the method comprising:
pre-filtering a real image of the at least portion of the piece;
adjusting a luminosity level in the real image to remove expected artefacts from at least one optical source;
matching a shape of a real laser profile to a shape of a virtual reference profile, and obtaining a distance between the real laser profile and the reference laser profile;
processing a luminance signal to identify a center of the real laser profile; and
recalculating the distance between the center of the real laser profile and the virtual reference laser profile.
